(19) United States
(12) Patent Application Publication
(10) Pub. No.: US 2010/0090455 A1
(43) Pub. Date: Apr. 15, 2010

(54) APPARATUS AND METHOD FOR MANUFACTURING A SECURITY PRODUCT

(75) Inventors: David R. Boswell, Berkshire (GB); Mark Robert Dicker, Isle of White (GB); Steven Winton, Berkshire (GB); Sébastien Villeneuve, Huningue (FR)

Correspondence Address: Ciba Corporation;Patent Department, 540 White Plains Road, P.O. Box 2005, Tarrytown, NY, 10591, US

(73) Assignee: CIBA CORPORATION, Tarrytown, NY (US)

(21) Appl. No.: 12/515,038

(22) PCT Filed: Nov. 15, 2007
(86) PCT No.: PCT/EP07/62377

§ 371 Date: Nov. 24, 2009

(30) Foreign Application Priority Data
Nov. 21, 2006 (EP) 06124504.9

(51) Int. Cl. B42D 15/00; G03B 27/54

(52) U.S. Cl. 283/57; 355/67

(57) ABSTRACT

The present invention relates to a method of printing, an apparatus for printing and to products obtained therefrom. In particular, the present invention relates to optically variable images, or devices applied to a substrate, such as a hologram, kinegram and the like. More particularly, the present invention concerns sub-microscopic, holographic, electron beam, mechanically ruled or other diffraction or straight line gratings.

The present invention relates to a method of printing, an apparatus for printing and to products obtained therefrom. In particular, the present invention relates to optically variable images, or devices applied to a substrate, such as a hologram, kinegram and the like. More particularly, the present invention concerns sub-microscopic, holographic, electron beam, mechanically ruled or other diffraction or straight line gratings.

The use diffraction grating patterns and images which include sub-microscopic, holographic, kinegraphic and other forms of optically variable device, especially on documents, banknotes, credit cards and packaging for decorative, and security purposes, has become commonplace. Nevertheless, despite such popular use, the utilisation of patterns and images is expensive and involves the manufacture of a pattern or image in one operation and, in a second separate operation, the pattern or image is transferred adhered or laminated to the intended substrate, document or article, examples of which are; banknotes, cheques, gift vouchers, credit/debit cards, security brand protection and non-secure label systems and packaging items.

Three-dimensional light diffracting patterns such as a hologram are the result of interfering two beams of coherent light at a finite angle with each other on a photosensitive medium. One beam is a reference beam and the other interacts with the object whose image is to be recorded. The resulting hologram is made having the image information recorded as surface variations of the holographic medium. A more rigid transfer master plate is subsequently made to form replica holographic images.

There are many methods to originate sub-microscopic or holographic optically variable device based on photoresist coated float glass plates, exposed to coherent light which have been manually or computer correlated, in the form of a microscopic pattern of fringes. This is manufactured by copying an original sub-microscopic or holographic diffraction grating origination. A transfer plate holding the sub-microscopic structure is used to produce a metal master copy from nickel. Subsequent generations of plates or shims can then be grown, by electroforming.

U.S. Pat. No. 4,913,858, discloses one method of embossing holographic diffraction pattern images into a plastic film or to a plastic coating of a substrate. The substrate is supplied with a coating of thermosensitive material having thermoplastic properties, heated to soften the coating using a heated cylinder alone or in combination with infra-red heaters and subsequently embossed to form a diffraction grating. The coated surface is then metallised by depositing a coating of metal on the diffraction grating. The diffraction pattern obtained from such a method can be flawed owing to distortions in the grating due to excessive pressure applied to the embossing roller to form the grating or if the thermosensitive material is heated too much there will be some adherence of the coating to the embossing roller. Clearly for a holographic diffraction grating, any distortions to the grating will adversely affect the quality of the hologram image. U.S. Pat. No. 4,728,377 discloses laminated sheet material having a support layer, a release coat covering the support layer, one or more layers of thermoplastic material overlying the release coat and less sensitive to heat than the release coat, and a layer of metal foil bonded to the surface of the thermoplastic layer. To form the diffraction grating, a die is impressed into the foil. The foil is then covered with an adhesive, the laminated sheet inverted and pressed against the item to which the diffraction grating is to be attached using a heated pressure plate whereby only the area of the sheet material under the pressure plate adheres to the item and separates from the support layer due to the melting of the release coat. When the support layer is lifted from the substrate, the foil and thermoplastic layers fracture along the edges of the pressure plate.

U.S. Pat. No. 5,087,510 discloses holograms having a relief-patterned metal surface electrolessly deposited on a relief-patterned polymeric substrate.

All of these documents describe forming a layer of metal, to provide a mirror-like luster, to improve the visibility of the image, into which a surface relief pattern is embossed using heated embossing members. If a discrete metallised pattern is desired, the overall surface is metallised followed by etching away unwanted metal using a suitable etchant such as an acid. Subsequently, in a separate operation the hologram is adhered or laminated to the intended document or article.

The methods described hereinabove require a significant amount of metal deposition to provide the luster effect, and, owing to the metal layer deposited, the image can only be viewed from the non-metallised surface of the substrate.

U.S. Pat. No. 5,549,774 discloses depositing metallic ink onto a transparent or translucent filmic sheet which has an embossed pattern, formed by pressing the sheet in contact with a heated nickel embossing shim at high pressure, on one surface and subsequently, in a separate operation, bonding a backing sheet having visual information to the embossed sheet.

As described above the application of high pressure and heat can adversely affect the integrity of the diffraction grating.

The separate operation of bonding a backing sheet, i.e. the substrate to which the hologram is to be applied, to the embossed filmic sheet reduces the speed of manufacture and can create further difficulties as the embossed filmic sheet and backing sheet must be carefully aligned so as to prevent incorrect positioning of the embossed material.

Furthermore, the application of high pressure and heat to emboss a filmic sheet, as described in U.S. Pat. No. 5,549,774, significantly reduces the speed of manufacture. Manufacturers have long sought to overcome the problems associated with the prior art with little or no success.

W02005051675 discloses a method and apparatus to print an optically variable device onto transparent filmic products. In contrast, the present invention provides a method for printing and an apparatus for applying an optically variable device and other lens and engraved structures, in-line at normal gravure speeds in conjunction with multiple other colours in one pass, on paper, aluminium, and all manner of other opaque substrates by means of the unique apparatus described below.

Advantageously, the present invention overcomes or alleviates one or more of the problems associated with the prior art.

In accordance with a first aspect of the present invention there is provided a method for forming an optically variable image on a substrate comprising the steps of:

A) applying a curable compound, or composition to at least a portion of the substrate;
B) contacting at least a portion of the curable compound with optically variable image forming means;
C) curing the curable compound and
D) optionally depositing a metallic ink on at least a portion of the cured compound, wherein the optically variable image forming means comprise
a) a transparent carrier,
b) a transparent material which carries an optically variable image to be applied, and
c) means to dry or cure a varnish.

Advantageously, the present invention provides a method of manufacture to transfer and optionally metallise a (sub-microscopic) optically variable image, such as a holographic or other diffraction grating directly onto the surface of a substrate and to do so with high productivity and low cost.

In a preferred embodiment the optically variable image forming means comprise

a) a transparent cylinder of quartz,
b) a transparent plastic material carrying the optically variable image to be applied, which is mounted on the surface of the quartz cylinder,
(c) means to dry or cure the varnish arranged within the transparent cylinder.

If the method is used for forming a security product, it may comprise the steps of:

A) providing a sheet of base material, said sheet having an upper and lower surface and being a component of the security product;
B) forming an optically variable image on at least a portion of the upper surface of the base material; and
C) depositing a metallic ink on at least a portion of the optically variable image.

In accordance with a further aspect of the present invention, there is provided an in-line method of printing on a substrate using a conventional printing press apparatus together with means for forming an optically variable image, comprising the steps of:

A) forming an optically variable image on a discrete portion of the substrate; and
B) depositing a metallic ink on at least a portion of the optically variable image.

Furthermore, it would be advantageous to form the optically variable image in register directly on the substrate to which the (sub-microscopic) image is to be applied.

In accordance with a further aspect of the present invention, there is provided an apparatus for forming a (security) product comprising a printing press and optically variable image forming means, wherein the optically variable image forming means comprise

a) a transparent carrier,
b) a transparent material which carries an optically variable image to be applied, and
c) means to dry or cure a varnish.

The transparent carrier is preferably a cylinder or a plate.

In a preferred embodiment the optically variable image forming means comprise

a) a transparent cylinder of quartz,
b) a transparent plastic material carrying the optically variable image to be applied, which is mounted on the surface of the quartz cylinder,
(c) means to dry or cure the varnish arranged within the transparent cylinder.

In an especially preferred embodiment an UV lamp is mounted in a water cooled quartz cylinder with an integral lens to polarize or concentrate the UV light into the nip area; the point at which the paper or other opaque substrate coated with the UV primer comes in contact with the transparent shim/plate which has the optically variable images held on its surface and mounted onto a transparent plastic cylinder made from polycarbonate or similar compound. Mounted concentric with this is a transparent cylinder running in free running or fixed bearings between the side plates. The clear shim carrying the optically variable image to be applied is attached to this roller. Several rollers could be provided so alternative images can be pre mounted, either to deal with different diameters with different repeats, or having systems to register image to print.

The printing press may comprise any one or more of a feed system; means to carry an image to be printed; means to apply an ink to; means to dry or cure the ink; means to carry the printed (security) product.

The feed system may be a sheet or web feed system.

The means to carry an image may comprise a set of cylinders or a plate. In one embodiment, making use of GRAVURE printing, the means to carry an image comprises a plurality of cylinders, each of which carries an engraved image for each coloured ink used. Each cylinder or plate for depositing/applying a colour is termed a print unit. There can be any number of print units. Preferably, however, there are between 1 and 10.

The means to carry the printed security product may comprise a delivery system for stacking sheets or holding finished reels.

In a preferred embodiment the printing press comprises in line, the optically variable image forming means to transfer the optically variable image to a substrate.

The above methods may all comprise subsequently printing of the base material or substrate with pigmented inks. Alternatively, the methods may all comprise the pre-step of printing the base material or substrate with pigmented inks.

In one embodiment, the base material or substrate is paper.

In accordance with a further aspect of the present invention, there is provided a method for forming a holographic diffraction grating on a substrate comprising the steps of:

A) depositing on at least a portion of the substrate a composition comprising a metallic ink admixed with a curable compound;
B) forming a diffraction grating on at least a portion of the composition.

In accordance with a further aspect of the present invention, there is provided a method for forming a holographic diffraction grating comprising the steps of:

A) providing a sheet of base material;
B) depositing a release coating to at least a portion of the base material;
C) depositing a curable compound, or composition on at least a portion of the coated base material;
D) forming a diffraction grating on at least a portion of the curable compound, or composition;
E) optionally depositing a metallic ink on at least a portion of the diffraction grating; and
F) depositing an adhesive on at least a portion of the metallic ink.

The present invention provides methods of transferring an optically variable image (OVI), such as a sub-microscopic image or holographic diffraction grating, and optionally by means of printing an ink, to form a composite sheet which when viewed from at least one surface of the substrate or base material reveals the formed sub-microscopic or holographic diffraction grating patterns or images.

The finished pattern or image may be fully printed with the metallic ink or have degrees of ink density which allows a partial metallisation effect of the image or pattern, whereby printing or text can be readily viewed through the image when applied to a paper, metal or filmic substrate, for use on security products such as banknotes, identification documents like passports, identification cards, drivers licenses, or other verification documents, pharmaceuticals, apparel, software, compact discs, tobacco and other products prone to counterfeiting or forgery, to protect them from fraudulent conversion, diversion i.e taking a product that should be sold in one market and selling it in another, or imitation.

The sub-microscopic images, holographic or other diffraction gratings may be transferred to the surface of the substrate specifically in registration or randomly for subsequent further registration of additional print units.

Once the image/pattern has been made visible by the overprinting of the metallic ink the image/pattern can not be again transferred to another surface other than by first depositing a release coat before forming the optically variable image and hot stamped conventionally the substrate either paper or filmic based.

The metallic ink provides a reflective background to the substrate. Preferably sufficient ink is deposited in one pass on conventional narrow or wide web printing presses, to provide the reflective background. The printing press preferably comprises in line, an apparatus to transfer the OVIs, such as sub-microscopic, holographic or other diffraction gratings.

In-line is defined herein as printing in one pass, one operation immediately after the next one on the same piece of machinery that is bolted together. Off-line is defined as a totally separate process carried out on another piece of equipment.

In one embodiment the substrate is pre-printed. Pre-printing of the substrate may be carried-out separately, offline, on other dedicated printing equipment or in line on apparatus in accordance with the present invention, i.e. a colored, or metallic ink is deposited on a substrate, on which the optically variable image is formed; before forming the optically variable image on at least a portion of the colored, or metallic ink.

An example of a metallic ink suitable for use in the methods and apparatus of the present invention is disclosed in WO2005049745.

Preferably, the thickness of the metallic ink when deposited on a substrate is sufficiently thin as to permit the transmission of light therethrough. Consequently, the metallic ink may be printed on the substrate over a sub-microscopic or holographic diffraction grating pattern or image, such that the diffraction grating pattern or image may be visible through both the upper and lower surface of the substrate.

Preferably, when the substrate carrying the metallised image or pattern is subsequently over-laid onto printed pictures and/or text, or the substrate is pre-printed with pictures and/or text and the metallised image or pattern is deposited thereon those printed features are visible through the substrate and/or the metallic ink coated optically variable image or device.

Preferably, the thickness of the metallised image or optically variable device is such as to provide an optical density in the range of light transmission. Optical densities of the layer of metallic ink can be measured by the Macbeth Densitometer set out in the following table:

| Macbeth Optical | Percent |
|---|---|
| Density Units | Transmission |
| 0.10 | 79.43 |
| 0.20 | 63.10 |
| 0.30 | 50.12 |
| 0.40 | 39.81 |
| 0.50 | 31.61 |

Preferably, the percentage of light transmission is at least 30%. More preferably, the percentage of light transmission is at least 50%, most preferably, 80%.

The apparatus may comprise means to continually move the substrate, for example a substrate feeder. The substrate may comprise any sheet material. The substrate may be opaque, substantially transparent or translucent, wherein the method of the present invention is especially suited for opaque (non-transparent substrates). The substrate may comprise paper, leather, fabric such as silk, cotton, tyvac, filmic material or metal, such as aluminium. The substrate may be in the form of one or more sheets or a web.

The substrate may be mould made, woven, non-woven, cast, calendared, blown, extruded and/or biaxially extruded.

The substrate may comprise paper, fabric, man made fibres and polymeric compounds. The substrate may comprise any one or more selected from the group comprising paper, papers made from wood pulp or cotton or synthetic wood free fibres and board. The paper/board may be coated, calendared or machine glazed; coated, uncoated, mould made with cotton or denim content, Tyvac, linen, cotton, silk, leather, polythyleneterephthalate, polypropylene propafilm, polyvinylchloride, rigid PVC, cellulose, tri-acetate, acetate polystyrene, polyethylene, nylon, acrylic and polytherimide board. The polythyleneterephthalate substrate may be Melienex type film orientated polypropylene (obtainable from DuPont Films Willimington Del. product ID Melinex HS-2).

The substrate may comprise papers and board made from wood pulp or cotton or synthetic wood free fibres. The paper/board may be coated, calendared or machine glazed.

The forming of an optically variable image on the substrate may comprise depositing a curable compound, or composition on at least a portion of the substrate. The composition, generally a coating or lacquer may be deposited by means of gravure, flexographic, ink jet and screen process printing. The curable lacquer may be cured by actinic radiations, preferably ultraviolet (U.V.) light or electron beam. Preferably, the lacquer is UV cured. UV curing lacquers can be obtained from Ciba Speciality Chemicals. The lacquers exposed to actinic radiations or electron beam used in the present invention are required to reach a solidified stage when they separate again from the imaging shim in order to keep the record in their upper layer of the sub-microscopic, holographic diffraction grating image or pattern (OVI). Particularly suitable for the lacquers compositions are chemistries used in the radiation curable industries in industrial coatings and graphic arts. Particularly suitable are compositions containing one or several photo-latent catalysts that will initiate polymerization of the exposed lacquer layer to actinic radiations. Particularly suitable for fast curing and conversion to a solid state are compositions comprising one or several monomers and oligomers sensitive to free-radical polymerization, such as acrylates, methacrylates or monomers or/and oligomers, containing at least one ethylenically unsaturated group. The unsaturated compounds may include one or more olefinic double bonds. They may be of low (monomeric) or high (oligomeric) molecular mass. Examples of monomers containing a double bond are alkyl, hydroxyalkyl or amino acrylates, or alkyl, hydroxyalkyl or amino methacrylates, for example methyl, ethyl, butyl, 2-ethylhexyl or 2-hydroxyethyl acrylate, isobornyl acrylate, methyl methacrylate or ethyl methacrylate. Silicone acrylates are also advantageous. Other examples are acrylonitrile, acrylamide, methacrylamide, N-substituted (meth)acrylamides, vinyl esters such as vinyl acetate, vinyl ethers such as isobutyl vinyl ether, styrene, alkyl- and halostyrenes, N-vinylpyrrolidone, vinyl chloride or vinylidene chloride.

Examples of monomers containing two or more double bonds are the diacrylates of ethylene glycol, propylene glycol, neopentyl glycol, hexamethylene glycol or of bisphenol A, and 4,4′-bis(2-acryl-oyloxyethoxy)diphenylpropane, trimethylolpropane triacrylate, pentaerythritol triacrylate or tetraacrylate, vinyl acrylate, divinylbenzene, divinyl succinate, diallyl phthalate, triallyl phosphate, triallyl isocyanurate or tris(2-acryloylethyl) isocyanurate.

Examples of polyunsaturated compounds of relatively high molecular mass (oligomers) are acrylated epoxy resins, polyesters containing acrylate-, vinyl ether- or epoxy-groups, and also polyurethanes and polyethers. Further examples of unsaturated oligomers are unsaturated polyester resins, which are usually prepared from maleic acid, phthalic acid and one or more diols and have molecular weights of from about 500 to 3000. In addition it is also possible to employ vinyl ether monomers and oligomers, and also maleate-terminated oligomers with polyester, polyurethane, polyether, polyvinyl ether and epoxy main chains. Of particular suitability are combinations of oligomers which carry vinyl ether groups and of polymers as described in WO90/01512. However, copolymers of vinyl ether and maleic acid-functionalized monomers are also suitable. Unsaturated oligomers of this kind can also be referred to as prepolymers.

Particularly suitable examples are esters of ethylenically unsaturated carboxylic acids and polyols or polyepoxides, and polymers having ethylenically unsaturated groups in the chain or in side groups, for example unsaturated polyesters, polyamides and polyurethanes and copolymers thereof, polymers and copolymers containing (meth)acrylic groups in side chains, and also mixtures of one or more such polymers.

Examples of unsaturated carboxylic acids are acrylic acid, methacrylic acid, crotonic acid, itaconic acid, cinnamic acid, and unsaturated fatty acids such as linolenic acid or oleic acid. Acrylic and methacrylic acid are preferred.

Suitable polyols are aromatic and, in particular, aliphatic and cycloaliphatic polyols. Examples of aromatic polyols are hydroquinone, 4,4′-dihydroxydiphenyl, 2,2-di(4-hydroxyphenyl)propane, and also novolaks and resols. Examples of polyepoxides are those based on the abovementioned polyols, especially the aromatic polyols, and epichlorohydrin. Other suitable polyols are polymers and copolymers containing hydroxyl groups in the polymer chain or in side groups, examples being polyvinyl alcohol and copolymers thereof or polyhydroxyalkyl methacrylates or copolymers thereof. Further polyols which are suitable are oligoesters having hydroxyl end groups.

Examples of aliphatic and cycloaliphatic polyols are alkylenediols having preferably 2 to 12 C atoms, such as ethylene glycol, 1,2- or 1,3-propanediol, 1,2-, 1,3- or 1,4-butanediol, pentanediol, hexanediol, octanediol, dodecanediol, diethylene glycol, triethylene glcyol, poly-ethylene glycols having molecular weights of preferably from 200 to 1500, 1,3-cyclopentanediol, 1,2-, 1,3- or 1,4-cyclohexanediol, 1,4-dihydroxymethylcyclohexane, glycerol, tris(β-hydroxyethyl)amine, trimethylolethane, trimethylolpropane, pentaerythritol, dipentaerythritol and sorbitol.

The polyols may be partially or completely esterified with one carboxylic acid or with different unsaturated carboxylic acids, and in partial esters the free hydroxyl groups may be modified, for example etherified or esterified with other carboxylic acids.

Examples of esters are: trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol tris-itaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetra methacrylate, sorbitol pentaacrylate, sorbitol hexaacrylate, oligoester acrylates and methacrylates, glycerol diacrylate and triacrylate, 1,4-cyclohexane diacrylate, bisacrylates and bismethacrylates of polyethylene glycol with a molecular weight of from 200 to 1500, or mixtures thereof.

Also suitable as polymerizable components are the amides of identical or different, unsaturated carboxylic acids with aromatic, cycloaliphatic and aliphatic polyamines having preferably 2 to 6, especially 2 to 4, amino groups. Examples of such polyamines are ethylenediamine, 1,2- or 1,3-propylenediamine, 1,2-, 1,3- or 1,4-butylenediamine, 1,5-pentylenediamine, 1,6-hexylenediamine, octylenediamine, dodecylenediamine, 1,4-diaminocyclohexane, isophoronediamine, phenylenediamine, bisphenylenediamine, di(β-aminoethyl ether, diethylenetriamine, triethylenetetramine, di(β-aminoethoxy)- or di(β-aminopropoxy)ethane. Other suitable polyamines are polymers and copolymers, preferably with additional amino groups in the side chain, and oligoamides having amino end groups. Examples of such unsaturated amides are methylenebisacrylamide, 1,6-hexamethylenebisacrylamide, diethylenetriaminetrismethacrylamide, bis(methacrylamidopropoxy)ethane, β-methacrylamidoethyl methacrylate and N[(β-hydroxyethoxy)ethyl]acrylamide.

Suitable unsaturated polyesters and polyamides are derived, for example, from maleic acid and from diols or diamines. Some of the maleic acid can be replaced by other dicarboxylic acids. They can be used together with ethylenically unsaturated comonomers, for example styrene. The polyesters and polyamides may also be derived from dicarboxylic acids and from ethylenically unsaturated diols or diamines, especially from those with relatively long chains of, for example 6 to 20 C atoms. Examples of polyurethanes are those composed of saturated or unsaturated diisocyanates and of unsaturated or, respectively, saturated diols.

Polymers with (meth)acrylate groups in the side chain are likewise known. They may, for example, be reaction products of epoxy resins based on novolaks with (meth)acrylic acid, or may be homo- or copolymers of vinyl alcohol or hydroxyalkyl derivatives thereof which are esterified with (meth)acrylic acid, or may be homo- and copolymers of (meth)acrylates which are esterified with hydroxyalkyl (meth)acrylates.

Other suitable polymers with acrylate or methacrylate groups in the side chains are, for example, solvent soluble or alkaline soluble polyimide precursors, for example poly(amic acid ester) compounds, having the photopolymerizable side groups either attached to the backbone or to the ester groups in the molecule, i.e. according to EP624826. Such oligomers or polymers can be formulated with optionally reactive diluents, like polyfunctional (meth)acrylates in order to prepare highly sensitive polyimide precursor resists.

Examples of polymerizable component are also polymers or oligomers having at least two ethylenically unsaturated groups and at least one carboxyl function within the molecule structure, such as a resin obtained by the reaction of a saturated or unsaturated polybasic acid anhy-dride with a product of the reaction of an epoxy compound and an unsaturated monocarboxylic acid, for example, photosensitive compounds as described in JP 10-301276 and commercial products such as for example EB9696, UCB Chemicals; KAYARAD TCR1025, Nippon Kayaku Co., LTD., NK OLIGO EA-6340, EA-7440 from Shin-Nakamura Chemical Co., Ltd., or an addition product formed between a carboxyl group-containing resin and an unsaturated compound having an β,β-unsaturated double bond and an epoxy group (for example, ACA200M, Daicel Industries, Ltd.). Additional commercial products as examples of polymerizable component are ACA200, ACA210P, ACA230AA, ACA250, ACA300, ACA320 from Daicel Chemical Industries, Ltd.

The photopolymerizable compounds are used alone or in any desired mixtures. It is preferred to use mixtures of polyol (meth)acrylates.

A preferred composition comprises at least one compound having at least one free carboxylic group, said compound being either subject of component (a) or of a binder polymer.

As diluent, a mono- or multi-functional ethylenically unsaturated compound, or mixtures of several of said compounds, can be included in the above composition up to 70% by weight based on the solid portion of the composition.

The invention also provides compositions comprising as polymerizable component at least one ethylenically unsaturated photopolymerizable compound which is emulsified or dissolved in water.

The unsaturated polymerizable components can also be used in admixture with non-photopolymerizable, film-forming components. These may, for example, be physically drying polymers or solutions thereof in organic solvents, for instance nitrocellulose or cellulose acetobutyrate. They may also, however, be chemically and/or thermally curable (heat-curable) resins, examples being polyisocyanates, polyepoxides and melamine resins, as well as polyimide precursors. The use of heat-curable resins at the same time is important for use in systems known as hybrid systems, which in a first stage are photopolymerized and in a second stage are crosslinked by means of thermal aftertreatment.

A photoinitiator is incorporated into the formulation to initiate the UV-curing process. Photoinitiator compounds are for example described by Kurt Dietliker in “A compilation of photoinitiators commercially available for UV today”, Sita Technology Ltd., Edinburgh and London, 2002, and by J. V. Crivello and K Dietliker in “Chemistry & Technology of UV & EB Formulation for Coatings, Inks and Paints; Photoinitiators for Free Radical, Cationic & Anionic Photopolymerization, Ed. 2, Vol. III, 1998, Sita Technology Ltd., London.

In certain cases it may be of advantage to use mixtures of two or more photoinitiators, for example mixtures with camphor quinone; benzophenone, benzophenone derivatives of the formula:

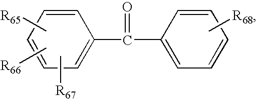

wherein
R₆₅, R₆₆ and R₆₇ independently of one another are hydrogen, C₁-C₄-alkyl, C₁-C₄-halogenalkyl, C₁-C₄-alkoxy, chlorine or N(C₁-C₄-alkyl)₂;
R₆₈ is hydrogen, C₁-C₄-alkyl, C₁-C₄-halogenalkyl, phenyl, N(C₁-C₄-alkyl)₂, COOCH₃,

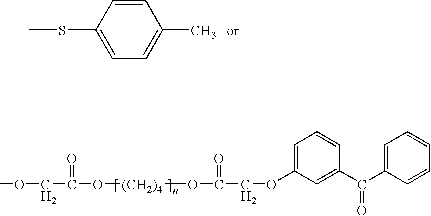

and
n is 2-10.

Specific examples are: 2,4,6-trimethylbenzophenone, 2-methylbenzophenone, 3-methylbenzophenone, 4-methylbenzophenone, 2-methoxycarbonylbenzophenone 4,4′-bis(chloromethyl)benzophenone, 4-chlorobenzophenone, 4-phenylbenzophenone, 3,3′-dimethyl-4-methoxy-benzophenone, [4-(4-methylphenylthio)phenyl]-phenylmethanone, methyl-2-benzoylbenzoate, 3-methyl-4′-phenylbenzophenone, 2,4,6-trimethyl-4′-phenylbenzophenone, 4,4′-bis(dimethylamino)benzophenone, 4,4′-bis(diethylamino)benzophenone; ESACURE TZT® available from Lamberti, (a mixture of 2,4,6-trimethylbenzophenone and 4-methylbenzophenone);

Ketal compounds, as for example benzildimethylketal (IRGACURE® 651); acetophenone, acetophenone derivatives, alpha-hydroxy ketones, alpha-alkoxyketones or alpha-aminoketones of the formula

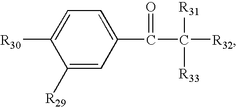

wherein
R₂₉ is hydrogen or C₁-C₁₈-alkoxy;
R₃₀ is hydrogen, C₁-C₁₈-alkyl, C₁-C₁₂hydroxyalkyl, C₁-C₁₈-alkoxy, —OCH₂CH₂—OR₄₇, morpholino, C₁-C₁₈alkyl-S—, a group H₂C═CH—, H₂C═C(CH₃)—,

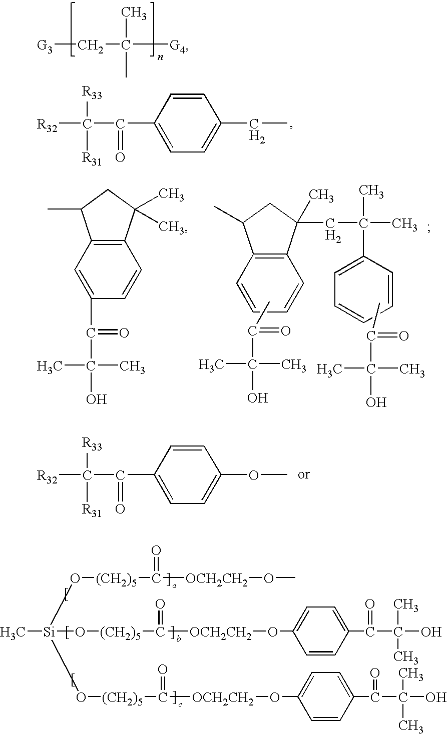

a, b and c are 1-3;
n is 2-10;
G₃ and G₄ independently of one another are end groups of the polymeric structure, preferably hydrogen or methyl;
R₄₇ is hydrogen,

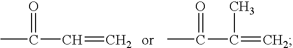

R₃₁ is hydroxy, C₁-C₁₆-alkoxy, morpholino, dimethylamino or —O(CH₂CH₂O)ₘ—C₁-C₁₆-alkyl;
R₃₂ and R₃₃ independently of one another are hydrogen, C₁-C₆-alkyl, C₁-C₁₆-alkoxy or —O(CH₂CH₂O)ₘ—C₁-C₁₆-alkyl; or unsubstituted phenyl or benzyl; or phenyl or benzyl substituted by C₁-C₁₂-alkyl; or R₃₂ and R₃₃ together with the carbon atom to which they are attached form a cyclohexyl ring;
m is 1-20, with the proviso that R₃₁, R₃₂ and R₃₃ not all together are C₁-C₁₆-alkoxy or —O(CH₂CH₂O)ₘ—C₁-C₁₆-alkyl.

For example α-hydroxycycloalkyl phenyl ketones or α-hydroxyalkyl phenyl ketones, such as for example 2-hydroxy-2-methyl-1-phenyl-propanone (DAROCUR® 1173), 1-hydroxy-cyclohexyl-phenyl-ketone (IRGACURE® 184), IRGACURE® 500 (a mixture of IRGACURE® 184 with benzophenone), 1-(4-dodecylbenzoyl)-1-hydroxy-1-methyl-ethane, 1-(4-isopropylbenzoyl)-1-hydroxy-1-methyl-ethane, 1-[4-(2-hydroxyethoxy)-phenyl]-2-hydroxy-2-methyl-1-propan-1-one (IRGACURE® 2959); 2-hydroxy-1-{4-[4-(2-hydroxy-2-methylpropionyl)-benzyl]-phenyl}-2-methyl-propan-1-one (IRGACURE®127); 2-Benzyl-1-(3,4-dimethoxy-phenyl)-2-dimethylamino-butan-1-one; 2-Hydroxy-1-{4-[4-(2-hydroxy-2-methyl-propionyl)-phenoxy]-phenyl}-2-methyl-propan-1-one,

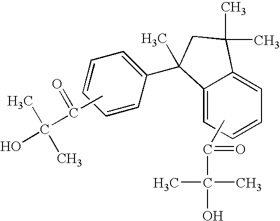

ESACURE KIP and ONE provided by Fratelli Lamberti, 2-hydroxy-1-{1-[4-(2-hydroxy-2-methyl-propionyl)-phenyl]-1,3,3-trimethyl-indan-5-yl}-2-methyl-propan-1-one dialkoxyacetophenones, α-hydroxy- or α-aminoacetophenones, e.g. (4-methylthiobenzoyl)-1-methyl-1-morpholinoethane (IRGACURE® 907), (4-morpholinobenzoyl)-1-benzyl-1-dimethylaminopropane (IRGACURE® 369), (4-morpholinobenzoyl)-1-(4-methylbenzyl)-1-dimethylaminopropane (IRGACURE® 379), (4-(2-hydroxyethyl)aminobenzoyl)-1-benzyl-1-dimethylaminopropane), 2-benzyl-2-dimethylamino-1-(3,4-dimethoxyphenyl) butanone-1; 4-aroyl-1,3-dioxolanes, benzoin alkyl ethers and benzil ketals, e.g. dimethyl benzil ketal, phenylglyoxalic esters and derivatives thereof, e.g. oxo-phenyl-acetic acid 2-(2-hydroxyethoxy)-ethyl ester, dimeric phenylglyoxalic esters, e.g. oxo-phenyl-acetic acid 1-methyl-2-[2-(2-oxo-2-phenyl-acetoxy)-propoxy]-ethyl ester (IRGACURE® 754); oximeesters, e.g. 1,2-octanedione 1-[4-(phenylhio)phenyl]-2-(O-benzoyloxime) (IRGACURE® OXE01), ethanone 1-[9-ethyl-6-(2-methylenzoyl)-9H-carbazol-3-yl]-1-(O-acetyloxime) (IRGACURE® OXE02), 9H-thioxanthene-2-carboxaldehyde 9-oxo-2-(O-acetyloxime), peresters, e,g. benzophenone tetracarboxylic peresters as described for example in EP 126541, monoacyl phosphine oxides, e.g. (2,4,6-trimethylbenzoyl)diphenylphosphine oxide (DAROCUR® TPO), ethyl (2,4,6 trimethylbenzoyl phenyl) phosphinic acid ester; bisacylphosphine oxides, e.g. bis(2,6-dimethoxy-benzoyl)-(2,4,4-trimethyl-pentyl)phosphine oxide, bis(2,4,6-trimethylbenzoyl)-phenylphosphine oxide (IRGACURE® 819), bis(2,4,6-trimethylbenzoyl)-2,4-dipentoxyphenylphosphine oxide, trisacylphosphine oxides, halomethyltriazines, e.g. 2-2-(4-methoxy-phenyl)-vinyl]-4,6-bis-trihlorothyl-[1,3,5]triazine, 2-(4-methoxy-phenyl)-4,6-bis-trichloromethyl-[1,3,5]triazine, 2-(3,4-di methoxy-phenyl)-4,6-bis-trichloromethyl-[1,3,5]triazine, 2-methyl-4,6-bis-trichloromethyl-[1,3,5]triazine, hexaarylbisimidazole/coinitiators systems, e.g. ortho-chlorohexaphenyl-bisimidazole combined with 2-mercaptobenzthiazole, ferrocenium compounds, or titanocenes, e.g. bis(cyclopentadienyl)-bis(2,6-difluoro-3-pyrryl-phenyl)titanium (IRGACURE®784). Further, borate compounds can be used as coinitiators.

Phenylglyoxalates of the formula

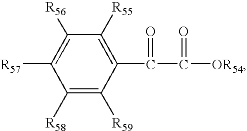

wherein
R₅₄ is hydrogen, C₁-C₁₂-alkyl or

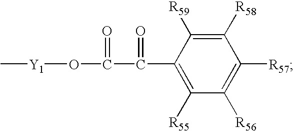

R₅₅, R₅₆, R₅₇, R₅₈ and R₅₉ independently of one another are hydrogen, unsubstituted C₁-C₁₂-alkyl or C₁-C₁₂-alkyl substituted by OH, C₁-C₄-alkoxy, phenyl, naphthyl, halogen or CN; wherein the alkyl chain optionally is interrupted by one or more oxygen atoms; or R₅₅, R₅₆, R₅₇, R₅₈ and R₅₉ independently of one another are C₁-C₄-alkoxy, C₁-C₄-alkylthio or NR₅₂R₅₃, R₅₂ and R₅₃ independently of one another are hydrogen, unsubstituted C₁-C₁₂-alkyl or C₁-C₁₂-alkyl substituted by OH or SH wherein the alkyl chain optionally is interrupted by one to four oxygen atoms; or R₅₂ and R₅₃ independently of one another are C₂-C₁₂-alkenyl, cyclopentyl, cyclohexyl, benzyl or phenyl; and
Y₁ is C₁-C₁₂-alkylene optionally interrupted by one or more oxygen atoms.

An example is oxo-phenyl-acetic acid 2-[2-(2-oxo-2-phenyl-acetoxy)-ethoxy]-ethyl ester (IRGACURE®754). A further example of a photoinitiator is Esacure 1001 available from Lamberti: 1-[4-(4-benzoylphenylsulfanyl)phenyl]-2-methyl-2-(4-methylphenylsulfonyl)propan-1-one

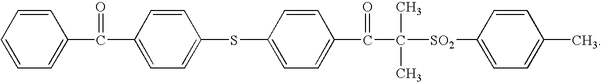

The photopolymerizable compositions generally comprise 0.05 to 20% by weight, preferably 0.01 to 10% by weight, in particular 0.01 to 8% by weight of the photoinitiator, based on the solid composition. The amount refers to the sum of all photoinitiators added, if mixtures of initiators are employed.

In addition to the photoinitiator, the photopolymerisable mixtures can comprise various additives. Examples thereof include thermal inhibitors, light stabilisers, optical brighteners, fillers and pigments, as well as white and coloured pigments, dyes, antistatics, adhesion promoters, wetting agents, flow auxiliaries, lubricants, waxes, anti-adhesive agents, dispersants, emulsifiers, anti-oxidants; fillers, e.g. talcum, gypsum, silicic acid, rutile, carbon black, zinc oxide, iron oxides; reaction accelerators, thickeners, matting agents, antifoams, and other adjuvants customary, for example, in lacquer, ink and coating technology.

To accelerate the photopolymerization it is possible to add amines as additives, for example triethanolamine, N-methyldiethanolamine, ethyl-p-dimethylaminobenzoate, 2-(dimethylamino)ethyl benzoate, 2-ethylhexyl-p-dimethylaminobenzoate, octyl-para-N,N-dimethylaminobenzoate, N-(2-hydroxyethyl)-N-methyl-para-toluidine or Michler's ketone. The action of the amines can be intensified by the addition of aromatic ketones of the benzophenone type. Examples of amines which can be used as oxygen scavengers are substituted N,N-dialkylanilines, as are described in EP339841. Other accelerators, coinitiators and autoxidizers are thiols, thioethers, disulfides, phosphonium salts, phosphine oxides or phosphines, as described, for example, in EP438123, in GB2180358 and in JP Kokai Hei 6-68309.

Photopolymerization can also be accelerated by adding further photosensitizers or coinitiators (as additive) which shift or broaden the spectral sensitivity. These are, in particular, aromatic compounds, for example benzophenone and derivatives thereof, thioxanthone and derivatives thereof, anthraquinone and derivatives thereof, coumarin and phenothiazine and derivatives thereof, and also 3-(aroylmethylene)thiazolines, rhodanine, camphorquinone, but also eosine, rhodamine, erythrosine, xanthene, thioxanthene, acridine, e.g. 9-phenylacridine, 1,7-bis(9-acridinyl)heptane, 1,5-bis(9-acridinyl)pentane, cyanine and merocyanine dyes.

As photosensitizers, it is also possible, for example, to consider the amines given above. Examples of suitable sensitizers are disclosed in WO06/008251, page 36, line 30 to page 38, line 8, the disclosure of which is hereby incorporated by reference.

Binders as well can be added to the novel compositions. This is particularly expedient when the photopolymerizable compounds are liquid or viscous substances. The quantity of binder may, for example, be 2-98%, preferably 5-95% and especially 20-90%, by weight relative to the overall solids content. The choice of binder is made depending on the field of application and on properties required for this field, such as the capacity for development in aqueous and organic solvent systems, adhesion to substrates and sensitivity to oxygen. Examples of suitable binders are polymers having a molecular weight of about 2,000 to 2,000,000, preferably 5,000 to 1,000,000.

Examples of alkali developable binders are acrylic polymer having carboxylic acid function as a pendant group, such as conventionally known copolymers obtained by copolymerizing an ethylenic unsaturated carboxylic acid such as (meth)acrylic acid, 2-carboxyethyl (meth)acrylic acid, 2-carboxypropyl (meth)acrylic acid itaconic acid, crotonic acid, maleic acid, fumaric acid and ω-carboxypolycaprolactone mono(meth)acrylate, with one or more monomers selected from esters of (meth)acrylic acid, such as methyl (meth)acrylate, ethyl (meth)acrylate, propyl (meth)acrylate, butyl (meth)acrylate, benzyl (meth)acrylate, 2-ethylhexyl (meth)acrylate, hydroxyethyl (meth)acrylate, hydroxypropyl (meth)acrylate, glycerol mono(meth)acrylate, tricyclo[5.2.1.0^{2,6}]decan-8-yl (meth)acrylate, glycidyl (meth)acrylate, 2-methylglycid (meth)acrylate, 3,4-epoxybutyl (meth)acrylate, 6,7-epoxyheptyl (meth)acrylate, N,N-dimethylaminoethyl (meth)acrylate, N,N-diethylaminoethyl (meth)acrylate, N,N-diethylaminoethyl (meth)acrylate, N,N-dimethylaminopropyl (meth)acrylate; vinyl aromatic compounds, such as styrene, α-methylstyrene, vinyltoluene, p-chlorostyrene, vinylbenzyl glycidyl ether, 4-vinylpyridine; amide type unsaturated compounds, (meth)acrylamide diacetone acrylamide, N-methylolacrylamide, N-butoxymethacrylamide N,N-dimethylacrylamide, N,N-dimethylaminopropyl (meth)acrylamide; and polyolefin type compounds, such as butadiene, isoprene, chloroprene and the like; methacrylonitrile, methyl isopropenyl ketone, mono-2-[(meth)acryloyloxy]ethyl succinate, N-phenylmaleimide, maleic anhydride, vinyl acetate, vinyl propionate, vinyl pivalate, vinylpyrrolidone, N,N-dimethylaminoethyl vinyl ether, diallylamine, polystyrene macro-monomer, or polymethyl (meth)acrylate macromonomer. Examples of copolymers are copolymers of acrylates and methacrylates with acrylic acid or methacrylic acid and with styrene or substituted styrene, phenolic resins, for example novolak, (poly)hydroxystyrene, and copolymers of hydroxystyrene with alkyl acrylates, acrylic acid and/or methacrylic acid. Preferable examples of copolymers are copolymers of methyl methacrylate/methacrylic acid, copolymers of benzyl methacrylate/methacrylic acid, copolymers of methyl methacrylate/-ethyl acrylate/methacrylic acid, copolymers of benzyl methacrylate/methacrylic acid/styrene, copolymers of benzyl methacrylate/methacrylic acid/hydroxyethyl methacrylate, copolymers of methyl methacrylate/butyl methacrylate/methacrylic acid/styrene, copolymers of methyl methacrylate/benzyl methacrylate/methacrylic acid/hydroxyphenyl methacrylate. Examples of solvent developable binder polymers are poly(alkyl methacrylates), poly(alkyl acrylates), poly(benzylmethacrylate-co-hydroxyethylmethacrylate-co-methacrylic acid), poly(benzyl-methacrylate-co-methacrylic acid); cellulose esters and cellulose ethers, such as cellulose acetate, cellulose acetobutyrate, methylcellulose, ethylcellulose; polyvinylbutyral, polyvinyl-formal, cyclized rubber, polyethers such as polyethylene oxide, polypropylene oxide and polytetrahydrofuran; polystyrene, polycarbonate, polyurethane, chlorinated polyolefins, polyvinyl chloride, vinyl chloride/vinylidene copolymers, copolymers of vinylidene chloride with acrylonitrile, methyl methacrylate and vinyl acetate, polyvinyl acetate, copoly-(ethylene/vinyl acetate), polymers such as polycaprolactam and poly(hexamethylene adipamide), and polyesters such as poly(ethylene glycol terephtalate) and poly(hexamethylene glycol succinate) and polyimide binder resins.

The polyimide binder resin can either be a solvent soluble polyimide or a polyimide precursor, for example, a poly(amic acid).

Interesting is a photopolymerizable composition, comprising as binder polymer, a copolymer of methacrylate and methacrylic acid. Interesting further are polymeric binder components as described e.g. in JP 10-171119-A.

“Dual curable” or “double curable” compositions can also be used in this application.

Previous compositions are efficiently cured by electron beam or in the presence of free-radical generating photoinitiators when irradiated with electromagnetic waves.

Particularly suitable for fast curing and conversion to a solid state are compositions comprising one or several monomers and oligomers sensitive to cationic polymerization, such as epoxy resins, glycidyl ethers, vinylethers, oxetanes or other monomers and oligomers that will homopolymerized or copolymerized in a cationic curable system. Corresponding compositions comprise as polymerizable component, for example, resins and compounds that can be cationically polymerised by alkyl- or aryl-containing cations or by protons. Examples thereof include cyclic ethers, especially epoxides and oxetanes, and also vinyl ethers and hydroxy-containing compounds. Lactone compounds and cyclic thioethers as well as vinyl thioethers can also be used. Further examples include aminoplastics or phenolic resole resins. These are especially melamine, urea, epoxy, phenolic, acrylic, polyester and alkyd resins, but especially mixtures of acrylic, polyester or alkyd resins with a melamine resin. These include also modified surface-coating resins, such as, for example, acrylic-modified polyester and alkyd resins. Examples of individual types of resins that are included under the terms acrylic, polyester and alkyd resins are described, for example, in Wagner, Sarx/Lackkunstharze (Munich, 1971), pages 86 to 123 and 229 to 238, or in Ullmann/Encyclopädie der techn. Chemie, 4^{th} edition, volume 15 (1978), pages 613 to 628, or Ullmann's Encyclopedia of Industrial Chemistry, Verlag Chemie, 1991, Vol. 18, 360 ff., Vol. A19, 371 if. The surface-coating preferably comprises an amino resin. Examples thereof include etherified and non-etherified melamine, urea, guanidine and biuret resins. Of special importance is acid catalysis for the curing of surface-coatings comprising etherified amino resins, such as, for example, methylated or butylated melamine resins (N-methoxymethyl- or N-butoxymethyl-melamine) or methylated/butylated glycolurils.

It is possible, for example, to use all customary epoxides, such as aromatic, aliphatic or cycloaliphatic epoxy resins. These are compounds having at least one, preferably at least two, epoxy group(s) in the molecule. Examples thereof are the glycidyl ethers and β-methyl glycidyl ethers of aliphatic or cycloaliphatic diols or polyols, e.g. those of ethylene glycol, propane-1,2-diol, propane-1,3-diol, butane-1,4-diol, diethylene glycol, polyethylene glycol, polypropylene glycol, glycerol, trimethylolpropane or 1,4-dimethylolcyclohexane or of 2,2-bis(4-hydroxycyclohexyl)propane and N,N-bis(2-hydroxyethyl)aniline; the glycidyl ethers of di- and poly-phenols, for example of resorcinol, of 4,4′-dihydroxyphenyl-2,2-propane, of novolaks or of 1,1,2,2-tetrakis(4-hydroxyphenyl)ethane. Examples thereof include phenyl glycidyl ether, p-tert-butyl glycidyl ether, o-icresyl glycidyl ether, polytetrahydrofuran glycidyl ether, n-butyl glycidyl ether, 2-ethylhexylglycidylether, C_{12/15}glycidyl ether and cyclohexanedimethanol diglycidyl ether. Further examples include N-glycidyl compounds, for example the glycidyl compounds of ethyleneurea, 1,3-propyleneurea or 5-dimethyl-hydantoin or of 4,4′-methylene-5,5′-tetramethyldihydantoin, or compounds such as triglycidyl isocyanurate.

Further examples of glycidyl ether components that are used in these formulations are, for example, glycidyl ethers of polyhydric phenols obtained by the reaction of polyhydric phenols with an excess of chlorohydrin, such as, for example, epichlorohydrin (e.g. glycidyl ethers of 2,2-bis(2,3-epoxypropoxyphenol)propane. Further examples of glycidyl ether epoxides that can be used in connection with the present invention are described, for example, in U.S. Pat. No. 3,018,262 and in “Handbook of Epoxy Resins” by Lee and Neville, McGraw-Hill Book Co., New York (1967).

There is also a large number of commercially available glycidyl ether epoxides that are suitable as component, such as, for example, glycidyl methacrylate, diglycidyl ethers of bisphenol A, for example those obtainable under the trade names EPON 828, EPON 825, EPON 1004 and EPON 1010 (Shell); DER-331, DER-332 and DER-334 (Dow Chemical); 1,4-butanediol diglycidyl ethers of phenolformaldehyde novolak, e.g. DEN-431, DEN-438 (Dow Chemical); and resorcinol diglycidyl ethers; alkyl glycidyl ethers, such as, for example, C₈-C₁₀glycidyl ethers, e.g. HELOXY Modifier 7, C₁₂-C₁₄glycidyl ethers, e.g. HELOXY Modifier 8, butyl glycidyl ethers, e.g. HELOXY Modifier 61, cresyl glycidyl ethers, e.g. HELOXY Modifier 62, p-tert-butylphenyl glycidyl ethers, e.g. HELOXY Modifier 65, polyfunctional glycidyl ethers, such as diglycidyl ethers of 1,4-butanediol, e.g. HELOXY Modifier 67, diglycidyl ethers of neopentyl glycol, e.g. HELOXY Modifier 68, diglycidyl ethers of cyclohexanedimethanol, e.g. HELOXY Modifier 107, trimethylolethane triglycidyl ethers, e.g. HELOXY Modifier 44, trimethylolpropane triglycidyl ethers, e.g. HELOXY Modifier 48, polyglycidyl ethers of aliphatic polyols, e.g. HELOXY Modifier 84 (all HELOXY glycidyl ethers are obtainable from Shell).

Also suitable are glycidyl ethers that comprise copolymers of acrylic esters, such as, for example, styrene-glycidyl methacrylate or methyl methacrylate-glycidyl acrylate. Examples thereof include 1:1 styrene/glycidyl methacrylate, 1:1 methyl methacrylate/glycidyl acrylate, 62.5:24:13.5 methyl methacrylate/ethyl acrylate/glycidyl methacrylate.

The polymers of the glycidyl ether compounds can, for example, also comprise other functionalities provided that these do not impair the cationic curing.

Other suitable glycidyl ether compounds that are commercially available are polyfunctional liquid and solid novolak glycidyl ether resins, e.g. PY 307, EPN 1179, EPN 1180, EPN 1182 and ECN 9699.

It will be understood that mixtures of different glycidyl ether compounds may also be used as component.

The glycidyl ethers are, for example, compounds of formula XX

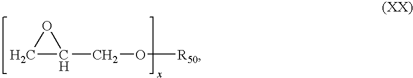

wherein
x is a number from 1 to 6; and
R₅₀ is a mono- to hexavalent alkyl or aryl radical.

Preference is given, for example, to glycidyl ether compounds of formula XX, wherein

x is the number 1, 2 or 3; and
R₅₀ when x=1, is unsubstituted or C₁-C₁₂alkyl-substituted phenyl, naphthyl, anthracyl, biphenylyl, C₁-C₂₀alkyl, or C₂-C₂₀alkyl interrupted by one or more oxygen atoms, or
R₅₀ when x=2, is 1,3-phenylene, 1,4-phenylene, C₆-C₁₀cycloalkylene, unsubstituted or halo-substituted C₁-C₄₀alkylene, C₂-C₄₀alkylene interrupted by one or more oxygen atoms, or a group

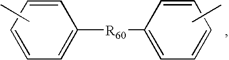

or
R₅₀ when x=3, is a radical

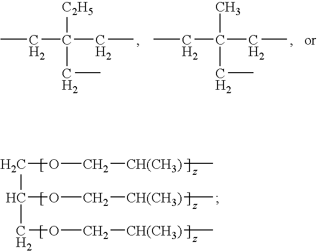

z is a number from 1 to 10; and
R₆₀ is C₁-C₂₀alkylene, oxygen or

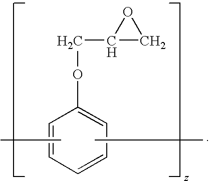

The glycidyl ethers (a1) are, for example, compounds of formula XXa

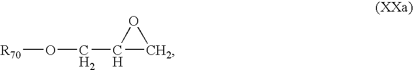

wherein
R₇₀ is unsubstituted or C₁-C₁₂alkyl-substituted phenyl; naphthyl; anthracyl; biphenylyl; C₁-C₂₀alkyl, C₂-C₂₀alkyl interrupted by one or more oxygen atoms; or a group of formula

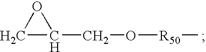

R₅₀ is phenylene, C₁-C₂₀alkylene, C₂-C₂₀alkylene interrupted by one or more oxygen atoms, or a group

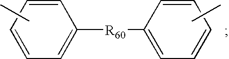

and
R₆₀ is C₁-C₂₀alkylene or oxygen.
Preference is given to the glycidyl ether compounds of formula XXb

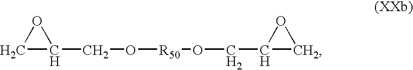

wherein
R₅₀ is phenylene, C₁-C₂₀alkylene, C₂-C₂₀alkylene interrupted by one or more oxygen atoms, or a group

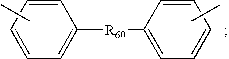

and
R₆₀ is C₁-C₂₀alkylene or oxygen.

Further examples for polymerizable component are polyglycidyl ethers and poly(β-methylglycidyl)ethers obtainable by the reaction of a compound containing at least two free alcoholic and/or phenolic hydroxy groups per molecule with the appropriate epichlorohydrin under alkaline conditions, or alternatively in the presence of an acid catalyst with subsequent alkali treatment. Mixtures of different polyols may also be used.

Such ethers can be prepared with poly(epichlorohydrin) from acyclic alcohols, such as ethylene glycol, diethylene glycol and higher poly(oxyethylene) glycols, propane-1,2-diol and poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylol-propane, pentaerythritol and sorbitol, from cycloaliphatic alcohols, such as resorcitol, quinitol, bis(4-hydroxycyclohexyl)methane, 2,2-bis(4-hydroxycyclohexyl)propane and 1,1-bis-(hydroxymethyl)cyclohex-3-ene, and from alcohols having aromatic nuclei, such as N,N-bis(2-hydroxyethyl)aniline and p,p'-bis(2-hydroxyethylamino)diphenylmethane. They can also be prepared from mononuclear phenols, such as resorcinol and hydroquinone, and polynuclear phenols, such as bis(4-hydroxyphenyl)methane, 4,4-dihydroxydiphenyl, bis(4-hydroxyphenyl)sulphone, 1,1,2,2-tetrakis(4-hydroxyphenyl)ethane, 2,2-bis(4-hydroxyphenyl)-propane (bisphenol A) and 2,2-bis(3,5-dibromo-4-hydroxyphenyl)propane.

Further hydroxy compounds suitable for the preparation of polyglycidyl ethers and poly(β-methylglycidyl)ethers are the novolaks obtainable by the condensation of aldehydes, such as formaldehyde, acetaldehyde, chloral and furfural, with phenols, such as, for example, phenol, o-cresol, m-cresol, p-cresol, 3,5-dimethylphenol, 4-chlorophenol and 4-tert-butylphenol.

Poly(N-glycidyl) compounds can be obtained, for example, by dehydrochlorination of the reaction products of epichlorohydrin with amines containing at least two aminohydrogen atoms, such as aniline, n-butylamine, bis(4-aminophenyl)methane, bis(4-aminophenyl)-propane, bis(4-methylaminophenyl)methane and bis(4-aminophenyl)ether, sulphone and sulphoxide. Further suitable poly(N-glycidyl) compounds include triglycidyl isocyanurate, and N,N′-diglycidyl derivatives of cyclic alkyleneureas, such as ethyleneurea and 1,3-propyleneurea, and hydantoins, such as, for example, 5,5-dimethylhydantoin. Poly(S-glycidyl) compounds are also suitable. Examples thereof include the di-S-glycidyl derivatives of dithiols, such as ethane-1,2-dithiol and bis(4-mercaptomethylphenyl)ether.

There also come into consideration epoxy resins in which the glycidyl groups or β-methyl glycidyl groups are bonded to hetero atoms of different types, for example the N,N,O-triglycidyl derivative of 4-aminophenol, the glycidyl ether/glycidyl ester of salicylic acid or p-hydroxybenzoic acid, N-glycidyl-N′-(2-glycidyloxypropyl)-5,5-dimethyl-hydantoin and 2-glycidyloxy-1,3-bis(5,5-dimethyl-1-glycidylhydantoin-3-yl)propane.

Preference is given to diglycidyl ethers of bisphenols. Examples thereof include diglycidyl ethers of bisphenol A, e.g. ARALDIT GY 250, diglycidyl ethers of bisphenol F and diglycidyl ethers of bisphenol S. Special preference is given to diglycidyl ethers of bisphenol A.

Further glycidyl compounds of technical importance are the glycidyl esters of carboxylic acids, especially di- and poly-carboxylic acids. Examples thereof are the glycidyl esters of succinic acid, adipic acid, azelaic acid, sebacic acid, phthalic acid, terephthalic acid, tetra- and hexa-hydrophthalic acid, isophthalic acid or trimellitic acid, or of dimerised fatty acids.

Examples of polyepoxides that are not glycidyl compounds are the epoxides of vinyl-cyclohexane and dicyclopentadiene, 3-(3′,4′-epoxycyclohexyl)-8,9-epoxy-2,4-dioxaspiro-[5.5]undecane, the 3′,4′-epoxycyclohexylmethyl esters of 3,4-epoxycyclohexanecarboxylic acid, (3,4-epoxycyclohexyl-methyl 3,4-epoxycyclohexanecarboxylate), butadiene diepoxide or isoprene diepoxide, epoxidised linoleic acid derivatives or epoxidised polybutadiene.

Further suitable epoxy compounds are, for example, limonene monoxide, epoxidised soybean oil, bisphenol-A and bisphenol-F epoxy resins, such as, for example, Araldit GY 250 (A), ARALDIT GY 282 (F), ARALDIT GY 285 (F)), and photocurable siloxanes that contain epoxy groups.

Further suitable cationically polymerisable or crosslinkable components can be found, for example, also in U.S. Pat. No. 3,117,099, U.S. Pat. No. 4,299,938 and U.S. Pat. No. 4,339,567.

From the group of aliphatic epoxides there are suitable especially the monofunctional symbol α-olefin epoxides having an unbranched chain consisting of 10, 12, 14 or 16 carbon atoms.

Because nowadays a large number of different epoxy compounds are commercially available, the properties of the binder can vary widely. One possible variation, for example depending upon the intended use of the composition, is the use of mixtures of different epoxy compounds and the addition of flexibilisers and reactive diluents.

The epoxy resins can be diluted with a solvent to facilitate application, for example when application is effected by spraying, but the epoxy compound is preferably used in the solventless state. Resins that are viscous to solid at room temperature can be applied hot.

Also suitable as crosslinkable components are all customary vinyl ethers, such as aromatic, aliphatic or cycloaliphatic vinyl ethers and also silicon-containing vinyl ethers. These are compounds having at least one, preferably at least two, vinyl ether groups in the molecule. Examples of vinyl ethers suitable for use in the compositions according to the invention include triethylene glycol divinyl ether, 1,4-cyclohexanedimethanol divinyl ether, 4-hydroxybutyl vinyl ether, the propenyl ether of propylene carbonate, dodecyl vinyl ether, tert-butyl vinyl ether, tert-amyl vinyl ether, cyclohexyl vinyl ether, 2-ethylhexyl vinyl ether, ethylene glycol monovinyl ether, butanediol monovinyl ether, hexanediol monovinyl ether, 1,4-cyclohexanedimethanol monovinyl ether, diethylene glycol monovinyl ether, ethylene glycol divinyl ether, ethylene glycol butylvinyl ether, butane-1,4-diol divinyl ether, hexanediol divinyl ether, diethylene glycol divinyl ether, triethylene glycol divinyl ether, triethylene glycol methylvinyl ether, tetra-ethylene glycol divinyl ether, pluriol-E-200 divinyl ether, polytetrahydrofuran divinyl ether-290, trimethylolpropane trivinyl ether, dipropylene glycol divinyl ether, octadecyl vinyl ether, (4-cyclohexyl-methyleneoxyethene)-glutaric acid methyl ester and (4-butoxyethene)-iso-phthalic acid ester.

Examples of hydroxy-containing compounds include polyester polyols, such as, for example, polycaprolactones or polyester adipate polyols, glycols and polyether polyols, castor oil, hydroxy-functional vinyl and acrylic resins, cellulose esters, such as cellulose acetate butyrate, and phenoxy resins.

Further cationically curable formulations can be found, for example, in EP119425.

As crosslinkable component, preference is given to cycloaliphatic epoxides, or epoxides based on bisphenol A.

Accordingly, the composition contains at least one compound selected from the group of cycloaliphatic epoxy compounds, glycidyl ethers, oxetane compounds, vinyl ethers, acid-crosslinkable melamine resins, acid-crosslinkable hydroxymethylene compounds and acid-crosslinkable alkoxy-methylene compounds.

If desired, the composition can also contain free-radically polymerisable components, such as ethylenically unsaturated monomers, oligomers or polymers.

It is also possible to use compounds that can be crosslinked equally both free-radically and cationically. Such compounds contain, for example, both a vinyl group and a cycloaliphatic epoxy group. Examples thereof are described in JP 2-289611-A and U.S. Pat. No. 6,048,953. Mixtures of two or more such free-radically polymerisable materials can also be used. Binders may also be added to the compositions, this being especially advantageous when the photopolymerisable compounds are liquid or viscous substances. The amount of binder may be, for example, from 5 to 95% by weight, preferably from 10 to 90% by weight and especially from 40 to 90% by weight, based on total solids. The unsaturated compounds may also be used in admixture with non-photopolymerisable film-forming components.

The alkyd resins used as crosslinkable component contain a large number of unsaturated, aliphatic compounds, at least some of which are polyunsaturated. The unsaturated aliphatic compounds preferably used for the preparation of those alkyd resins are unsaturated aliphatic monocarboxylic acids, especially polyunsaturated aliphatic monocarboxylic acids. Examples of mono-unsaturated fatty acids are myristoleic acid, palmitic acid, oleic acid, gadoleic acid, erucic acid and ricinoleic acid. Preferably fatty acids containing conjugated double bonds, such as dehydrogenated castor oil fatty acid and/or tung oil fatty acid, are used. Other suitable monocarboxylic acids include tetrahydrobenzoic acid and hydrogenated or non-hydrogenated abietic acid or the isomers thereof. If desired, the monocarboxylic acid in question may be used wholly or in part in the form of a triglyceride, e.g. as vegetable oil, in the preparation of the alkyd resin. If desired, mixtures of two or more such mono-carboxylic acids or triglycerides may be used, optionally in the presence of one or more saturated, (cyclo)aliphatic or aromatic monocarboxylic acids, e.g. pivalic acid, 2-ethyl-hexanoic acid, lauric acid, palmitic acid, stearic acid, 4-tert-butyl-benzoic acid, cyclo-pentanecarboxylic acid, naphthenic acid, cyclohexanecarboxylic acid, 2,4-dimethylbenzoic acid, 2-methylbenzoic acid and benzoic acid.

If desired, polycarboxylic acids may also be incorporated into the alkyd resin, such as phthalic acid, isophthalic acid, terephthalic acid, 5-tert-butylisophthalic acid, trimellitic acid, pyromellitic acid, succinic acid, adipic acid, 2,2,4-trimethyladipic acid, azelaic acid, sebacic acid, dimerised fatty acids, cyclopentane-1,2-dicarboxylic acid, cyclohexane-1,2-dicarboxylic acid, 4-methylcyclohexane-1,2-dicarboxylic acid, tetrahydrophthalic acid, endomethylene-cyclohexane-1,2-dicarboxylic acid, butane-1,2,3,4-tetracarboxylic acid, endoisopropylidene-cyclohexane-1,2-dicarboxylic acid, cyclohexane-1,2,4,5-tetracarboxylic acid and butane-1,2,3,4-tetracarboxylic acid. If desired, the carboxylic acid in question may be used as an anhydride or in the form of an ester, for example an ester of an alcohol having from 1 to 4 carbon atoms.

In addition, the alkyd resin can be composed of di- or poly-valent hydroxyl compounds. Examples of suitable divalent hydroxyl compounds are ethylene glycol, 1,3-propanediol, 1,6-hexanediol, 1,12-dodecanediol, 3-methyl-1,5-pentanediol, 2,2,4-trimethyl-1,6-hexane-diol, 2,2-dimethyl-1,3-propanediol and 2-methyl-2-cyclohexyl-1,3-propanediol. Examples of suitable triols are glycerol, trimethylolethane and trimethylolpropane. Suitable polyols having more than 3 hydroxyl groups are pentaerythritol, sorbitol and etherified products of the compounds in question, such as ditrimethylolpropane and di-, tri- and tetra-pentaerythritol. Preferably, compounds having from 3 to 12 carbon atoms, e.g. glycerol, pentaerythritol and/or dipentaerythritol, are used.

The alkyd resins can be obtained by direct esterification of the constituents, with the option that some of those components may already have been converted into ester diols or polyester diols. The unsaturated fatty acids can also be used in the form of a drying oil, such as linseed oil, tuna fish oil, dehydrogenated castor oil, coconut oil and dehydrogenated coconut oil. The final alkyd resin is then obtained by transesterification with the other acids and diols added. The transesterification is advantageously carried out at a temperature in the range of from 115 to 250° C., optionally in the presence of solvents such as toluene and/or xylene. The reaction is advantageously carried out in the presence of a catalytic amount of a transesterification catalyst. Examples of suitable transesterification catalysts include acids, such as p-toluenesulphonic acid, basic compounds, such as an amine, or compounds such as calcium oxide, zinc oxide, tetraisopropyl orthotitanate, dibutyltin oxide and triphenylbenzylphosphonium chloride.

The vinyl ether, acetal and/or alkoxysilane compounds used as part of crosslinkable component preferably contain at least two vinyl ether, acetal and/or alkoxysilane groups and have a molecular weight of 150 or more. Those vinyl ether, acetal and/or alkoxysilane compounds can be obtained, for example, by the reaction of a commercially available vinyl ether, acetal and/or alkoxysilane compound containing a vinyl ether, acetal and/or alkoxysilane group and in addition a maximum of one functional amino, epoxy, thiol, isocyanate, acrylic, hydride or hydroxyl group, with a compound having at least two groups capable of reacting with an amino, epoxy, thiol, isocyanate, acrylic, hydride or hydroxyl group. As examples thereof there may be mentioned compounds having at least two epoxy, isocyanate, hydroxyl and/or ester groups or compounds having at least two ethylenically or ethynylenically unsaturated groups.

As polymerizable component, preference is given to a composition in which the vinyl ether, acetal and/or alkoxysilane compounds are covalently bonded to the alkyd resin by addition via a reactive group such as an amino, hydroxyl, thiol, hydride, epoxy and/or isocyanate group. For that purpose, the compounds must have at least one group capable of forming an adduct with the reactive groups present in the alkyd resin.

To incorporate vinyl ether groups into the alkyd resin, use is made of a vinyloxyalkyl compound, the alkyl group of which is substituted by a reactive group, such as a hydroxyl, amino, epoxy or isocyanate group, that is capable of forming an adduct with one or more of the reactive groups present in the alkyd resin.

As polymerizable component, preference is given to compositions in which the ratio of the number of oxidatively drying groups present in the alkyd resin to the number of groups that are reactive in the presence of an acid is in the range of from 1/10 to 15/1, especially from 1/3 to 5/1. Instead of a single modified alkyd resin, it is also possible to use a plurality of alkyd resins, with one alkyd resin being highly modified and the others being less modified or not modified at all.

Examples of vinyl ether compounds capable of being covalently bonded to the alkyd resin are ethylene glycol monovinyl ether, butanediol monovinyl ether, hexanediol monovinyl ether, triethylene glycol monovinyl ether, cyclohexanedimethanol monovinyl ether, 2-ethylhexanediol monovinyl ether, polytetrahydrofuran monovinyl ether, tetraethylene glycol monovinyl ether, trimethylolpropane divinyl ether and aminopropyl vinyl ether.

Adducts can be formed, for example, by reacting the vinyl ether compounds containing a hydroxyl group or amino group with an excess of a diisocyanate, followed by the reaction of that free-isocyanate-group-containing adduct with the free hydroxyl groups of the alkyd resin. Preferably, a process is used in which first the free hydroxyl groups of the alkyd resin react with an excess of a polyisocyanate, and then the free isocyanate groups react with an amino-group- or hydroxyl-group-containing vinyl ether compound. Instead of a diisocyanate, it is also possible to use a diester. Transesterification of the hydroxyl groups present in the alkyd resin with an excess of the diester, followed by transesterification or transamidation of the remaining ester groups with hydroxy-functional vinyl ether compounds or amino-functional vinyl ether compounds, respectively, yields vinyl-ether-functional alkyd resins. It is also possible to incorporate (meth)acrylate groups into the alkyd resin during preparation of the alkyd resin, by carrying out the preparation in the presence of a hydroxy-functional (meth)acrylate ester, such as hydroxyethyl methacrylate (HEMA), and then reacting the thus functionalised alkyd resin by means of a Michael reaction with a vinyl-ether-group-containing compound and a primary-amino-group-containing compound, followed by reaction with e.g. an isocyanate compound, in order to obtain a non-basic nitrogen atom.

An example of such a reaction is described, for example, in WO99/47617. Esterification of ricinine fatty acid with dipentaerythritol, followed by transesterification of the free hydroxyl groups with diethyl malonate and 4-hydroxybutyl vinyl ether in a suitable ratio, yields a vinyl-ether-functional alkyd resin suitable for use as polymerizable component.

When free-radically polymerisable components are added to the formulation according to the invention, it may be advantageous to add also a suitable free-radical photoinitiator or a mixture of such photoinitiators

A compound that increases the solubility of the cationically or acid-catalytically polymerisable or crosslinkable compound in a developer under the action of acid;

The photopolymerisable mixtures can comprise various additives in addition to the photoinitiator. Examples thereof include thermal inhibitors, light stabilisers, optical brighteners, fillers and pigments, as well as white and coloured pigments, dyes, antistatics, adhesion promoters, wetting agents, flow auxiliaries, lubricants, waxes, anti-adhesive agents, dispersants, emulsifiers, anti-oxidants; fillers, e.g. talcum, gypsum, silicic acid, rutile, carbon black, zinc oxide, iron oxides; reaction accelerators, thickeners, matting agents, antifoams, and other adjuvants customary, for example, in lacquer, ink and coating technology.

Acceleration of the photopolymerisation can also be effected by adding as further additives photosensitisers that shift or broaden the spectral sensitivity. These are especially aromatic carbonyl compounds, such as, for example, benzophenone, thioxanthone, and especially also isopropylthioxanthone, phenothiazine derivatives, anthraquinone and 3-acyl-coumarin derivatives, terphenyls, styryl ketones, and 3-(aroylmethylene)-thiazolines, camphorquinone, and also eosin, rhodamine and erythrosin dyes, and anthracene derivatives, such as, for example, 9-methylanthracene, 9,10-dimethylanthracene, 9,10-diethoxyanthracene, 9,10-dibutyloxyanthracene, 9-methoxyanthracene, 9-anthracenemethanol, especially 9,10-dimethoxy-2-ethyl-anthracene, 9,10-dibutyloxyanthracene and 9,10-diethoxyanthracene. Further suitable photosensitisers are mentioned, for example, in WO 98/47046. Further examples of suitable photosensitisers are disclosed in WO 06/008251, page 36, line 30 to page 38, line 8, the disclosure of which is hereby incorporated by reference.

The sensitisers described above are customary in the art and are accordingly used in amounts customary in the art, preferably in a concentration of from 0.05 to 5%, especially in a concentration of from 0.1 to 2%, based on the composition.

The compositions according to the invention may additionally comprise further photoinitiators (e), such as, for example, cationic photoinitiators, photo acid-formers and free-radical photoinitiators as co-initiators in amounts of from 0.01 to 15%, preferably from 0.1 to 5%.

It is also possible to use electron donor compounds, such as, for example, alkyl- and aryl-amine donor compounds, in the composition. Such compounds are, for example, 4-di-methylaminobenzoic acid, ethyl 4-dimethylaminobenzoate, 3-dimethylaminobenzoic acid, 4-dimethylaminobenzoin, 4-dimethylaminobenzaldehyde, 4-dimethylaminobenzonitrile and 1,2,4-tri-methoxybenzene. Such donor compounds are preferably used in a concentration of from 0.01 to 5%, especially in a concentration of from 0.05 to 0.50%, based on the formulation.

Examples of cationic photoinitiators and acid-formers are phosphonium salts, diazonium salts, pyridinium salts, iodonium salts, such as for example tolylcumyliodonium tetrakis(pentafluorophenyl)borate, 4-[(2-hydroxy-tetradecyloxy)phenyl]phenyliodonium hexafluoroantimonate or hexafluorophosphate (SarCat® CD 1012; Sartomer), tolylcumyliodonium hexafluorophosphate, 4-isobutylphenyl-4′-methylphenyliodonium hexafluorophosphate (IRGACURE® 250, Ciba Specialty Chemicals), 4-octyloxyphenyl-phenyliodonium hexafluorophosphate or hexafluoroantimonate, bis(dodecylphenyl)iodonium hexafluoroantimonate or hexafluorophosphate, bis(4-methylphenyl)iodonium hexafluorophosphate, bis(4-methoxyphenyl)iodonium hexafluorophosphate, 4-methylphenyl-4′-ethoxyphenyliodonium hexafluorophosphate, 4-methylphenyl-4′-dodecylphenyliodonium hexafluorophosphate, 4-methylphenyl-4′-phenoxyphenyliodonium hexafluorophosphate. Of all the iodonium salts mentioned, compounds with other anions are, of course, also suitable; further sulphonium salts, obtainable, for example, under the trade names CYRACURE® UVI-6990, CYRACURE® UVI-6974 (Union Carbide), DEGACURE® KI 85 (Degussa), SP-55, SP-150, SP-170 (Asahi Denka), GE UVE 1014 (General Electric), SarCat® KI-85 (=triarylsulphonium hexafluorophosphate; Sartomer), SarCat® CD 1010 (=mixed triarylsulphonium hexafluoroantimonate; Sartomer); SarCat® CD 1011(=mixed triarylsulphonium hexafluorophosphate; Sartomer); ferrocenium salts, e.g. (η⁶-isopropylbenzene)(η⁵-cyclopentadienyl)-iron-II hexafluorophosphate, nitrobenzylsulphonates, alkyl- and aryl-N-sulphonyloxyimides and further known alkylsulphonic acid esters, haloalkylsulphonic acid esters, 1,2-disulphones, oxime sulphonates, benzoin tosylate, tolylsulphonyloxy-2-hydroxy-2-methyl-1-phenyl-1-propanone and further known beta-ketosulphones, beta-sulphonylsulphones, bis(alkylsulphonyl)diazomethane, bis(4-tert-butyl-phenyl-sulphonyl)-diazomethane, benzoyl-tosyl-diazomethane, iminosulphonates and imidosulphonates and trichloromethyl-s-triazines and other haloalkyl-group-containing compounds. Examples of further suitable additional photolatent acids (b1) include the examples of cationic photoinitiators and acid-formers as given in WO04/074242, page 38, line 10 to page 41, line 14, as well as the compounds disclosed in the examples of WO04/074242, the relevant disclosure of which is incorporated herein by reference.

Exposure to radiation can be followed by a thermal post-curing step.

Previous compositions are efficiently cured by electron beam or when irradiated with electromagnetic waves in the presence of photo-acid generators and in particular cationic photoinitiators such as ionium salts, in particular sulfonium and iodonium salts.

Also suitable for fast curing and conversion to a solid state are compositions comprising one or several monomers and oligomers sensitive to polycondensation catalysed by photolatent bases. Photolatent bases are in particular photolatent tertiary amines or amidines. Examples of photolatent bases comprise compounds of the formula I,

Z-A (I), wherein

Z is a photolabile group; and
A is an amidine or amine base precursor group, covalently bonded to Z.

Examples of compounds Z-A are compounds of formula

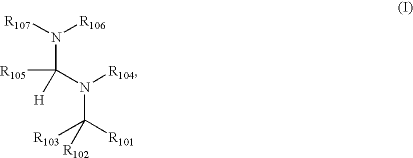

in which
R₁₀₁ is phenyl, biphenyl, naphthyl, anthryl or anthraquinonyl which is unsubstituted or substituted by one or more of the substituents C₁-C₄-alkyl, C₂-C₄-alkenyl, CN, OR₁₁₀, SR₁₁₀, COOR₁₁₂, halogen or a substituent of structure (II)

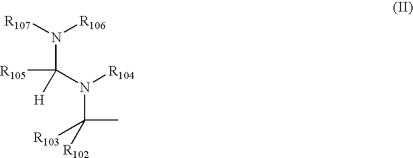

or
R₁₀₁ is a substituent of formula (III)

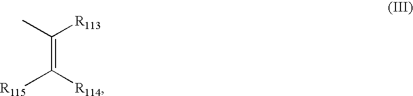

R₁₁₃ is phenyl, biphenyl, naphthyl, anthryl or anthraquinonyl which is unsubstituted or substituted by one or more of the substituents C₁-C₄-alkyl, C₂-C₄-alkenyl, CN, OR₁₁₀, SR₁₁₀, COR₁₁₁, COOR₁₁₂, or halogen;
R₁₁₄ is hydrogen
R₁₁₅ is hydrogen or C₁-C₄-alkyl;
R₁₀₂ and R₁₀₃ independently of each other are hydrogen or C₁-C₆-alkyl;
R₁₀₄ and R₁₀₆ together form a C₂-C₆-alkylene bridge that is unsubstituted or substituted by one or more C₁-C₄-alkyl groups; or
R₁₀₅ and R₁₀₇, together form a C₂-C₆-alkylene bridge that is unsubstituted or substituted by one or more C₁-C₄-alkyl groups;
R₁₁₀, R₁₁₁ and R₁₁₂ independently of each other are hydrogen or C₁-C₆-alkyl; or compounds of formula

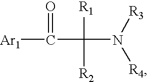

in which
Ar₁ is an aromatic radical of formula V or VIII

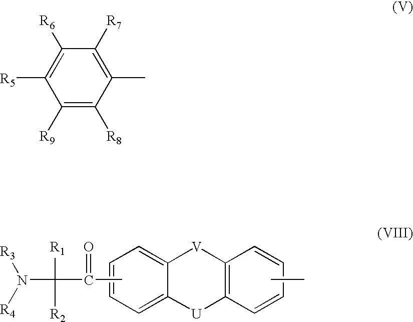

### U is N(R₁₇)—;

V has the meaning of U or is a direct bond;
R₁ and R₂ are each independently of each other
a) C₁-C₁₂-alkyl, which is unsubstituted or substituted by OH, C₁-C₄-alkoxy, or SH,
b) a radical of formula

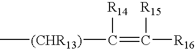

### Or

c) a radical of formula

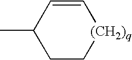

in which q is 0, or 1, or
d) a radical of formula

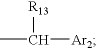

e) phenyl which is unsubstituted or substituted C₁-C₄-alkyl;

or R₁ and R₂ together are unbranched or branched C₄-C₆-alkylene or C₃-C₅-oxaalkylene,

Ar₂ is a phenyl radical which is unsubstituted or substituted by halogen, OH, C₁-C₁₂-alkyl, or is substituted by C₁-C₄-alkyl, which is substituted by OH, halogen, C₁-C₁₂-alkoxy, —COO(C₁-C₄-alkyl), —CO(OCH₂CH₂)ₙOCH₃ or —OCO(C₁-C₄-alkyl), or the radical phenyl, is substituted by C₁-C₄-alkoxy, —(OCH₂CH₂)ₙOH, or —(OCH₂CH₂)ₙOCH₃, with n is 1-5
R₃ is C₁-C₄-alkyl, C₂-C₄-alkyl which is substituted by —OH, —C₁-C₄-alkoxy, —CN, or —COO(C₁-C₄-alkyl), or R₃ is C₃-C₅-alkenyl, or phenyl-C₁-C₃-alkyl-;
R₄ is C₁-C₄-alkyl, C₂-C₄-alkyl which is substituted by —OH, —C₁-C₄-alkoxy, —CN, or —COO(C₁-C₄-alkyl), or R₃ is C₃-C₅-alkenyl, or phenyl-C₁-C₃-alkyl-, or R₃ and R₄ together are C₃-C₇-alkylene which can be interrupted by —O—, or —S—;
R₅, R₆, R₇, R₈ and R₉ are each independently of one another hydrogen, halogen, C₁-C₁₂-alkyl, phenyl, benzyl, benzoyl, or a group —OR₁₇, —SR₁₈, —N(R₁₉)(R₂₀), or

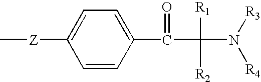

### Z is ±0-, —S—, —N(R₁₁)—, —N(R₁₁)—R₁₂—N(R₁₁)— or

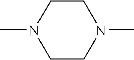

R₁₁ is C₁-C₄-alkyl,
R₁₂ is unbranched or branched C₂-C₁₆-alkylene which can be interrupted by one or more —O— or —S—
R₁₃ is hydrogen or C₁-C₄-alkyl;
R₁₄, R₁₅ and R₁₆ are each independently of one another hydrogen or C₁-C₄-alkyl, or R₁₄ and R₁₅ together are C₃-C₄-alkylene;
R₁₇ is hydrogen, C₁-C₁₂-alkyl, C₃-C₆-alkenyl, C₂-C₆-alkyl which is substituted by —CN, —OH or —COO(C₁-C₄-alkyl);
R₁₈ is hydrogen, C₁-C₁₂-alkyl, C₃-C₆-alkenyl, C₂-C₁₂-alkyl which is substituted by —OH, —CN, —COO(C₁-C₄-alkyl),
R₁₉ and R₂₀ are each independently of the other C₁-C₆-alkyl, C₂-C₄-hydroxyalkyl, C₂-C₁₀-alkoxyalkyl, C₃-C₅-alkenyl, phenyl-C₁-C₃-alkyl, phenyl which is unsubstituted or substituted by C₁-C₄-alkyl or C₁-C₄-alkoxy, or R₁₉ and R₂₀ are C₂-C₃-alkanoyl or benzoyl, or R₁₉ and R₂₀ are —O(CO—C₁-C₈)ₒ—OH with o is 1-15
or R₁₉ and R₂₀ together are C₄-C₆-alkylene which can be interrupted by —O—, —N(R₂₂)— or —S—, or R₁₉ and R₂₀ together are C₄-C₆-alkylene which can be substituted by hydroxyl, C₁-C₄-alkoxy or —COO(C₁-C₄-alkyl);
R₂₂ is C₁-C₄-alkyl, phenyl-C₁-C₃-alkyl, —CH₂CH₂—COO (C₁-C₄-alkyl), —CH₂CH₂CN, —CH₂CH₂—COO(CH₂CH₂O)_{q}—H or

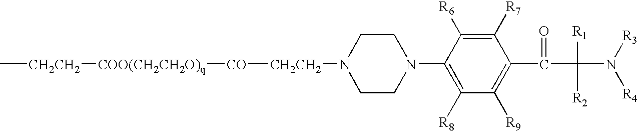

and q is 1-8.

In addition to the photolatent catalyst, the photopolymerisable mixtures can comprise various additives. Examples thereof include thermal inhibitors, light stabilisers, optical brighteners, fillers and pigments, as well as white and coloured pigments, dyes, antistatics, adhesion promoters, wetting agents, flow auxiliaries, lubricants, waxes, anti-adhesive agents, dispersants, emulsifiers, anti-oxidants; fillers, e.g. talcum, gypsum, silicic acid, rutile, carbon black, zinc oxide, iron oxides; reaction accelerators, thickeners, matting agents, antifoams, and other adjuvants customary, for example, in lacquer, ink and coating technology. Photopolymerization can also be accelerated by adding further photosensitizers or coinitiators (as additive) which shift or broaden the spectral sensitivity. These are, in particular, aromatic compounds, for example benzophenone and derivatives thereof, thioxanthone and derivatives thereof, anthraquinone and derivatives thereof, coumarin and phenothiazine and derivatives thereof, and also 3-(aroylmethylene)thiazolines, rhodanine, camphorquinone, but also eosine, rhodamine, erythrosine, xanthene, thioxanthene, acridine, e.g. 9-phenylacridine, 1,7-bis(9-acridinyl)heptane, 1,5-bis(9-acridinyl)pentane, cyanine and merocyanine dyes.

Particularly preferred oligomeric/polymeric systems are binders which are customary in the industry and known to the person skilled in the art.

Examples of base-catalysable binders of this kind are:

a) acrylic copolymers with alkoxysilane and/or alkoxysiloxane side groups, examples being the polymers described in U.S. Pat. No. 4,772,672, U.S. Pat. No. 4,444,974 or EP1092757;
b) two-component systems comprising hydroxyl-containing polyacrylates, polyesters and/or polyethers and aliphatic or aromatic polyisocyanates;
c) two-component systems comprising functional polyacrylates and a mono- or multi-functionalized epoxide component, the polyacrylate containing thiol, amino, carboxyl and/or anhydride groups, as described, for example, in EP 898202;
d) two-component systems comprising fluorine-modified or silicone-modified, hydroxyl-containing polyacrylates, polyesters and/or polyethers and aliphatic or aromatic polyisocyanates;
e) two-component systems comprising (poly)ketimines and aliphatic or aromatic polyisocyanates;
f) two-component systems comprising (poly)ketimines and unsaturated acrylic resins or acetoacetate resins or methyl α-acrylamidomethylglycolate;
g) two-component systems comprising (poly)oxazolidines and polyacrylates containing anhydride groups or unsaturated acrylic resins or polyisocyanates;
h) two-component systems comprising epoxy-functional polyacrylates and carboxyl-containing or amino-containing polyacrylates;
i) polymers based on allyl glycidyl ether;
j) two-component systems comprising a (poly)alcohol and/or (poly)thiol and a (poly)isocyanate;
k) two-component systems comprising an α,β-ethylenically unsaturated carbonyl compound and a polymer containing activated CH₂ groups, the activated CH₂ groups being present either in the main chain or in the side chain or in both, as is described, for example, in EP 161697 for (poly)malonate groups. Other compounds containing activated CH₂ groups are (poly)acetoacetates and (poly)cyanoacetates.
l) Two-component systems comprising a polymer containing activated CH₂ groups, the activated CH₂ groups being present either in the main chain or in the side chain or in both, or a polymer containing activated CH₂ groups such as (poly)acetoacetates and (poly)cyanoacetates, and a polyaldehyde crosslinker, such as terephthalaldehyde. Such systems are described, for example, in Urankar et al., Polym. Prepr. (1994), 35, 933.
n) Two-component or one-component systems comprising blocked isocyanates and a hydrogen donor. Such systems are described for example in PCT/EP2007/056917, the disclosure of which hereby is incorporated by reference.
o) Thiol Michael systems. Examples are described by F. Cellesi et al. in Biomaterials (2004), 25(21), 5115.

Within this group of base-catalysable binders, the following are particularly preferred:

b) two-component systems comprising hydroxyl-containing polyacrylates, polyesters and/or polyethers and aliphatic or aromatic polyisocyanates;
c) two-component systems comprising functional polyacrylates and a mono- or multi-functionalized epoxide component, the polyacrylate containing thiol, amino, carboxyl and/or anhydride groups, as described, for example, in EP 898202;
m) two-component systems comprising a (poly)alcohol and/or (poly)thiol and a (poly)isocyanate;
n) two-component systems comprising an α,β-ethylenically unsaturated carbonyl compound and a polymer containing activated CH₂ groups, the activated CH₂ groups being present either in the main chain or in the side chain or in both. Exposure to radiation can be followed by a thermal post-curing step.

Also suitable for fast curing and conversion to a solid state are compositions consisting in combinations of the previously described chemistries, often named as hybrid curing system. Additives other than catalysts, fillers, resins, pre-polymers may also be added to improve curing, cured film/layer properties, and separation from the imaging shim.

The lacquer or coating to be polymerized will have a viscosity and more generally rheology adapted to the coating or printing process used that enable an efficient and if possible consistent transfer of a wet film thickness just superior to the depth of the sub-microscopic, holographic diffraction grating image or pattern (OVI). Generally, the wet coating layer will be comprised between 0.1 and 100 μm and preferably 1 to 25 μm.

A large number of the most varied kinds of light source may be used. Both point sources and planiform radiators (lamp arrays) are suitable. Examples are carbon arc lamps, xenon arc lamps, medium-pressure, super-high-pressure, high-pressure and low-pressure mercury radiators doped, where appropriate, with metal halides (metal halide lamps), microwave-excited metal vapour lamps, excimer lamps, superactinic fluorescent tubes, fluorescent lamps, argon incandescent lamps, flash lamps, photographic floodlight lamps, light-emitting diodes (LED), electron beams and X-rays. Advantageously the dose of radiation used in process step c) is e.g. from 1 to 1000 mJ/cm². When the lamp is a medium pressure mercury lamp, it may have a power in the range of 40-450 Watts. Preferably, the U.V. lamp is disposed on (plate) or in (cylinder) the means for forming an optically variable image.

The U.V. light source may comprise a lamp. The lamp may have a power in the range of 200-450 Watts. Preferably, the U.V. lamp is disposed on (plate) or in (cylinder) the means for forming an optically variable image.

In one embodiment, the transfer speed of the sub-microscopic, holographic diffraction grating image or pattern (OVI) onto the surface of the printed lacquer will vary according to the power of the curing lamps. Preferably, the transfer speed is in the range of 10 metres to 20,000 metres per hour, more preferably 18,000 metres per hour. Whilst in contact with the lacquer the sub-microscopic or holographic diffraction grating is formed on the surface of the ultraviolet curable lacquer disposed on the upper surface of the substrate.

The metallic ink may be applied to the substrate by means of conventional printing press such as gravure, rotogravure, flexographic, lithographic, offset, letterpress intaglio and/or screen process, or other printing process. The substrate may then be rewound for subsequent off line printing at a later stage or alternatively, the substrate may be pre-printed in line or off line or subsequently printed in line.

The metal-based ink may comprise metal pigment particles and a binder.

The metal pigment particles may comprise any suitable metal. Nonlimiting examples of suitable metallic materials include aluminum, silver, copper, gold, platinum, tin, titanium, palladium, nickel, cobalt, rhodium, niobium, stainless steel, nichrome, chromium, and compounds, combinations or alloys thereof. The particles may comprise any one or more selected from the group comprising aluminium, gold, silver, platinum and copper. Preferably, the particles comprise aluminium, silver and/or copper flakes.

The metallic ink may be prepared by any means known to the skilled man. Preferably, a 12-micron thick transparent carrier film such as Polythyleneterephthalate obtained from DuPont Films Wilmington. Del. (Product ID Melinex HS-2) two metres wide is gravure coated with an acrylic resin isobutyl methacrylate obtained from DuPont (Product ID Elvacite 2045) and dried by means of hot air. In a second operation the acrylic-coated film is deposition coated with aluminium by means of a roll to roll vacuum chamber. The deposition rate and thickness of the vaporised aluminium layer over the printed acrylic coating is accurately controlled through continuos monitoring of the optical density during manufacture. The operating range of vacuum deposition may be in the range of 100 to 500 angstroms thick, the preferred thickness is in the range of 190 to 210 angstroms thick.

The optical density may be in the range of 0.2 to 0.8 as measured on the McBeth densitomiter. Preferably, the range is 0.5 to 0.8. More preferably, the optical density is 0.7 as measured on the McBeth densitomiter.

The metal layer may comprise aluminium, stainless steel, nichrome, gold, silver, platinum or any other metal which can be vaporised and deposited by vacuum deposition or applied by sputtering or electron beam deposition. Preferably, the metal layer comprises aluminium. The aluminium layer may be removed from the carrier film by means of dissolving the acrylic supporting layer in a bath containing ethyl acetate releasing the aluminium layer from the carrier film. The resulting aluminium in the form of a coarse flake in the resin solution may then be washed in a multi stage centrifuging process to remove the acrylic resin. The coarse aluminium flakes are mixed with ethyl acetate and disintegrated by a high shear mixing process to produce a controlled particle size distribution. The average particle diameter may be in the range of 8 to 15 microns, the preferred range being 9 to 10 microns diameter as measured by a Coulter LS130 l.a.s.e.r. diffraction granulometer.

In order that the sub-microscopic or holographic diffraction grating pattern or image is clearly visible on both the first and second surface of a clear filmic substrate and the first surface of a paper substrate, preferably, the aluminium or other flakes are printed in such a way as to align themselves with the contours of the sub-microscopic, holographic or other diffraction grating pattern or image surface wave length such that the flakes conform to and follow the contours of the diffraction grating.

To accomplish this alignment of flakes to the contours of the diffraction grating wave length i.e. the distance between peak and peak or trough and trough of the sub-microscopic contour, the specifically formulated metallic ink preferably has a very low binder content, high pigment to binder ratio and very thin aluminium flake, preferably in the range of 9 to 10 microns, consistent to maintain good adhesion of the ink to the surface to the sub-microscopic or holographic diffraction pattern or image.

The binder may comprise any one or more selected from the group comprising nitro cellulose, vinyl chloride, vinyl acetate copolymers, vinyl, acrylic, urethane, polythyleneterephthalate, terpene phenol, polyolefin, silicone, cellulose, polyamide, rosin ester resins. The preferred binder is 50% nitrocellulose (ID nitrocellulose DHL120/170 and nitrocellulose DLX30/50 supplied by Nobel Industries) 50% polyurethane (ID Neorez U335 supplied by Avecia). The solvents may be ester/alcohol blends and preferably normal propyl acetate and ethanol in a ratio of 20:1 to 30:1.

The preferred pigment to binder ratio is by weight in the range of 1.5:1 to 3.0:1, preferably 2.5:1. The metal pigment content of the ink may be the range of 2% to 4% by weight, and preferably 3%.

The means for forming a diffraction grating may comprise a shim or a seamless roller. The shim or roller may be manufactured from any suitable transparent material, such as, for example, polyester. Polyester shims may be made by coating polyester with an ultraviolet curable lacquer and contact copying the master image and curing the transferred image by means of ultraviolet light. In a preferred embodiment an acrylic sheet is coated with UV lacquer/varnish; a nickel shim holding the images is then applied under pressure to the wet acrylic sheet and then the lacquer/varnish is cured through the clear acrylic sheet. Required is a UV lacquer/varnish that will adhere to the acrylic and not the nickel shim when cured. The UV lacquer may comprise an epoxy-acrylate from the CRAYNOR® Sartomer Europe range (10 to 60%) and one or several acrylates (monofunctional and multifunctional), monomers which are available from Sartomer Europe (20 to 90%) and one, or several photoinitiators (1 to 15%) such as Darocure® 1173 and a levelling agent such as BYK®361 (0.01 to 1%) from BYK Chemie.

Seamless cylinders may be made by coating polyester with an ultraviolet curable lacquer and contact copying the master image and curing the transferred image by means of ultraviolet light.

The invention relates also to a method for producing a seam free transfer cylinder for the production and use of optically variable devices and patterns in printing. More particularly the invention is directed to a method of manufacturing a cylinder with optically variable diffraction and other sub-microscopic gratings constructed to obscure perceivable joint lines and seams associated with conventional embossing systems using nickel shims as the vehicle to impart the grating to a substrate.

The preferred method for the cylinder construction is to emboss an OVD grating structure, like a hologram, electron beam strait grating or other diffractive sub-microscopic gratings, into a roll of clear biaxially orientated polypropylene (BOPP) having a thickness in the range of 20 to 100 microns. Preferably the holographic, other grating structure, or none holographic image can be imparted into the surface of the BOPP film by means of hard embossing, a method which employs nickels shims normally in the range of 150 mm to 300 mm square. The nickels shims are heated and the grating structure is pressed into the surface of the BOPP film. None holographic images or structures like diamond gratings, machine ruled or similar can be an etched image.

Next, a cylinder is placed in a custom made assembly used for coating and decorating with the grating structures and is cleaned. The required length of the embossed BOPP film is slightly larger than the surface area of the cylinder. A tape with low tack adhesive is applied to the surface of the cylinder and the embossed BOPP film is adhered to the cylinder along one edge horizontally; ensuring embossed surface is facing the cylinder. Then the embossed BOPP film is folded back over tape edge so that the embossing surface is facing upwards. A quantity of UV adhesive is run along a roller just below the taped edge. The BOPP film is folded back over and run through a nip and held in nip back edge of the film, whereby the adhesive spreads under the film and on the surface of the cylinder. The coated area is cured by using an UV light source. Then the cylinder is run through the rest of nip until the BOPP film is clear. The BOPP film is peeled back from the un-taped edge first, wherein the image is transferred to the roll via the UV adhesive. The BOPP film and the tape are removed.

The trailing edge is cleaned off and the above process is repeated, ensuring the BOPP film is taped to top surface of the trailing edge image or accurately line up the image. The process is repeated until the cylinder is covered with the image. The cylinder is removed and placed in a silicone casting rig. The outer casing of the casting rig is a split case. This is to enable the removal of cylinder and silicone once cast. When the cylinder is in place, the gap between the cylinder surface and inside walls of the rig is filled with silicone. This is an addition cure silicone not a Room Temperature Vulcanizing (RTV) silicone. The casting system can also be made from clear acrylic which can also be a split casting. Instead of using an addition cure silicone a UV cure silicone can be used. Once the system is filled with UV silicone it can be cured through the clear acrylic wall. Once cured the casting casing is split and the cylinder with the cured silicone surface is removed. The roller and cured silicone are placed in a vacuum removal rig. A vacuum is applied to pull silicone off the roller and remove roller. Then the silicone mould is removed and placed in a second split casting rig, the place in casting transfer mandrel. A heat curing resin is filled between silicone and casting mandrel, the resin is cured. The casting casing is split and the silicone and cured roller are removed, when the resin is cured. The roller and cured silicone are placed in vacuum removal rig as described above and the mandrel with the cured resin is removed.

The mandrel with cured resin is now ready to transfer the gratings by means of the process of the present invention.

In addition, in the first part of the process the decorated cylinder prior to casting can also be used for conventional soft embossing. If an UV system is used which does not re-act with the UV used in transferring the gratings using the process of the present invention, it can also be used for UV embossing.

In another embodiment a cylinder is coated with ultraviolet curable resin, placing a clear transfer film with a sub-microscopic or holographic diffraction pattern or image to the surface of the ultraviolet resin via a nip and cured with ultraviolet light. The cylinder can then be subsequently cast, as described above and used to directly transfer the sub-microscopic or holographic diffraction pattern or image into the surface of a printed ultraviolet cured lacquer on the first surface of a substrate. Alternatively, the substrate may be subsequently printed with metallic ink off-line on conventional printing equipment.

The upper surface of the substrate may be printed with a metallic ink in discrete registered i.e. registered with other print already on the document etc., or in a position on the document etc., so that other subsequent printing can take place and/or non-registered areas as images/patterns, or in a stripe in discrete registered and/or non-registered or all over the substrate surface. The substrate may then pass through a nip roller to a cylinder carrying sub-microscopic, holographic or other diffraction grating pattern or image in the form of a polyester shim affixed to the surface of a cylinder. In a preferred embodiment the images or patterns are held on a seamless cylinder with the sub-microscopic pattern or image on it, so that the accuracy of the transfer can be improved a cylinder. The sub-microscopic optically variable image or holographic grating may then be transferred from the shim or seamless roller into the surface of the exposed ultraviolet lacquer by means of bringing the surface of the shim or seamless roller into contact with the surface of the exposed ultraviolet lacquer. An ultraviolet light source may be exposed through the surface of the transparent OVI forming means and instantly cures the lacquer by exposure to ultraviolet light. The ultraviolet light sources may be lamps in the range of 200 watts to 450 watts disposed inside the cylinder, curing through the printed ultraviolet lacquer and fixing the transferred sub-microscopic or holographic diffraction grating.

Specific embodiments of the present invention will now be described, by way of example only, with reference to the accompanying examples and figures, in which:

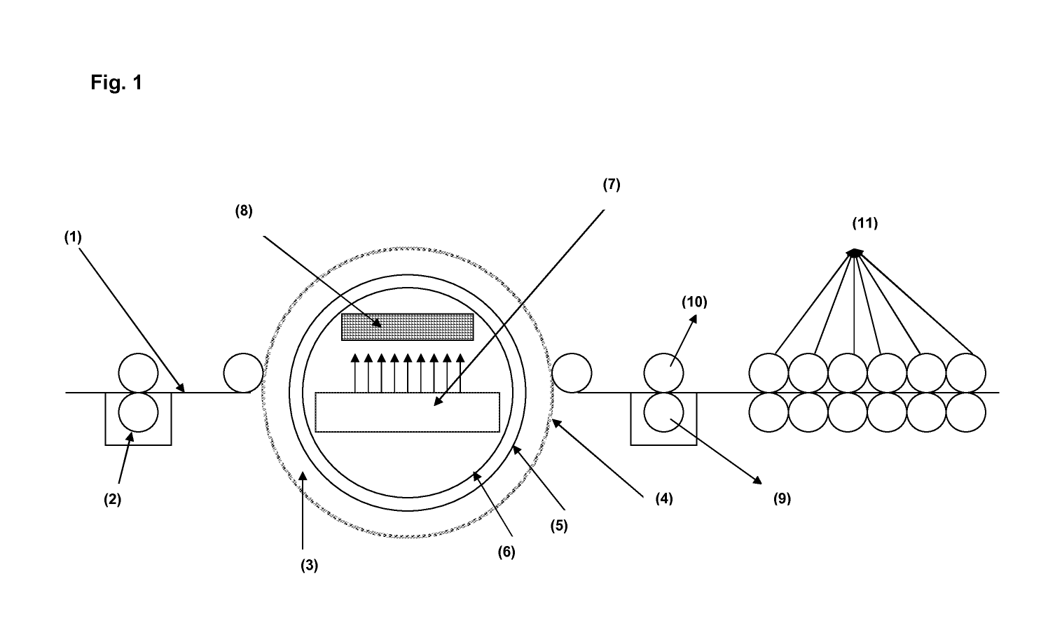

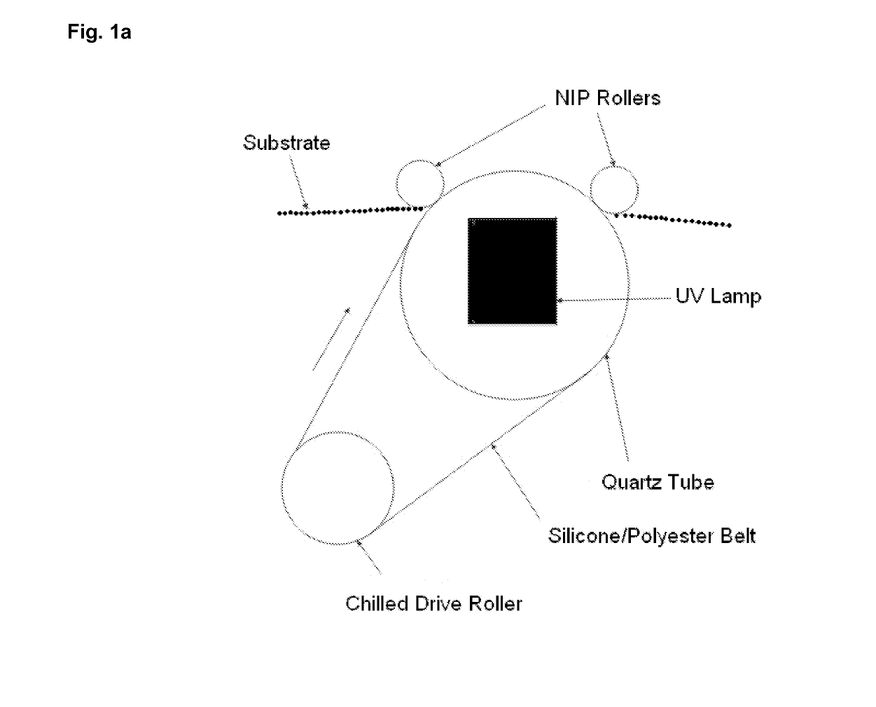

FIG. 1 is a schematic representation of a process for creating an optically variable image in accordance with the present invention using direct ultraviolet curable lacquer over-printed with metallic ink;

FIG. 1a shows a belt system comprising a quartz tube having an UV lamp mounted inside, a chilled drive roller and a silicone-polyester belt containing the holographic image;

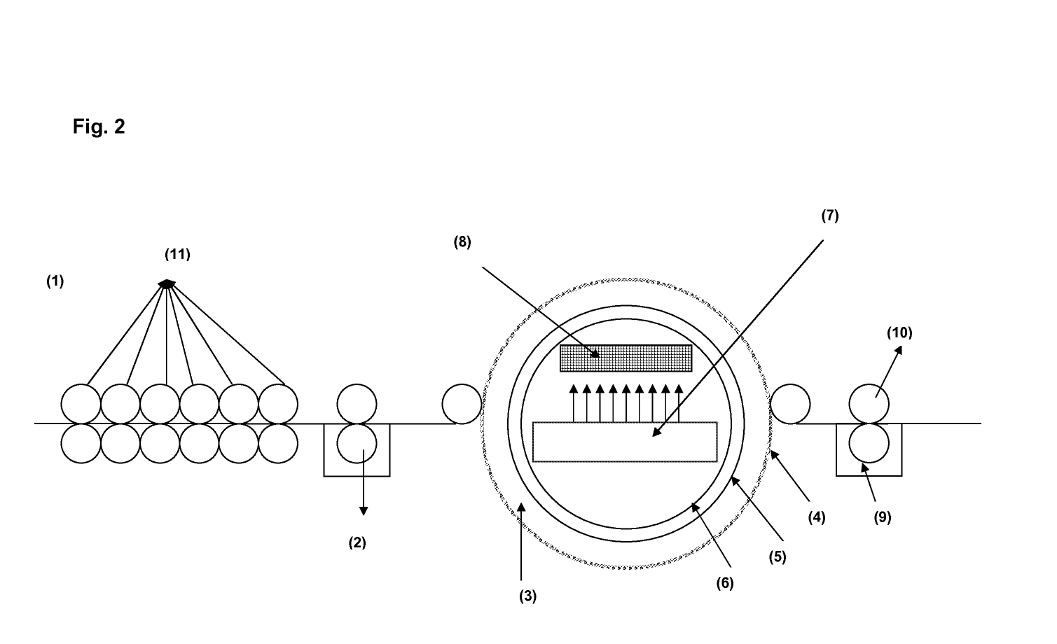

FIG. 2 is a schematic representation of the process of FIG. 1 reversed;

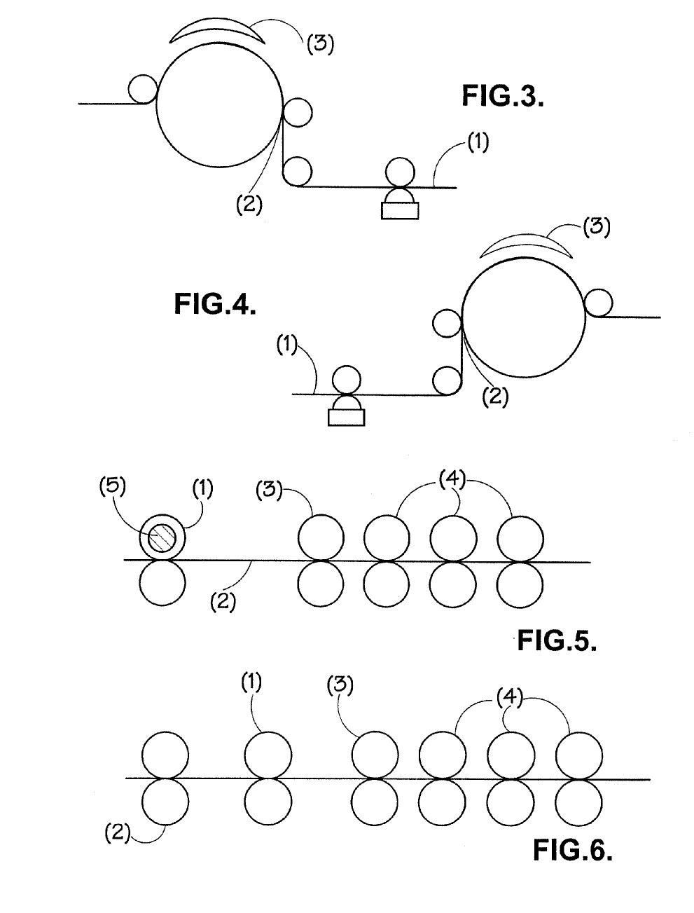

FIG. 3 is a schematic representation of a process for creating a sub-microscopic, holographic or other diffraction grating in accordance with the present invention using an ultraviolet curable metallic ink;

FIG. 4 is a schematic representation of the process of FIG. 3 reversed;

FIG. 5 is a schematic representation of a conventional printing process having an embossing station added in-line;

FIG. 6 is a schematic representation of a conventional printing process having an embossing station added in-line;

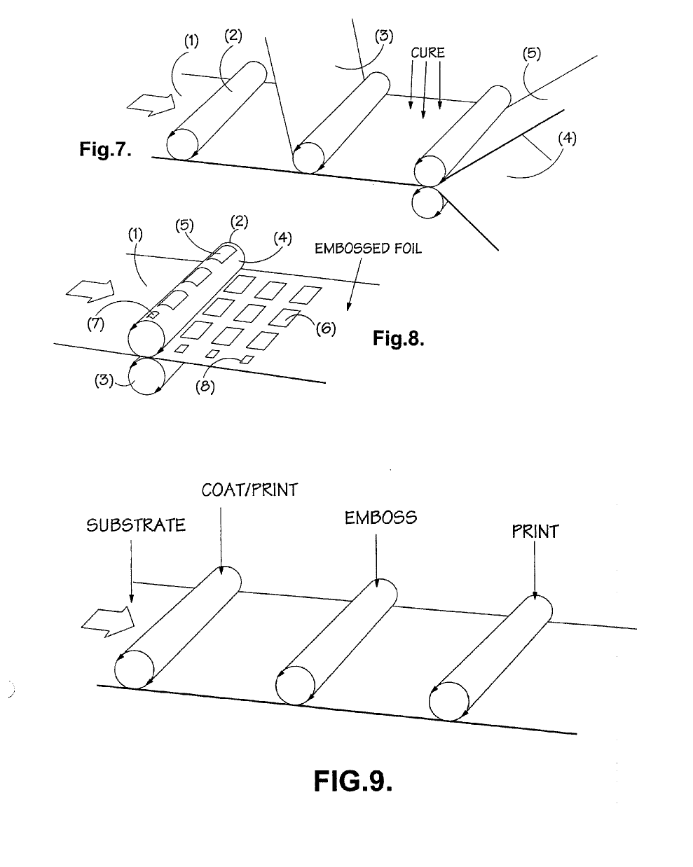

FIG. 7 is a perspective view of a schematic representation as shown in FIGS. 3, 4 and 6;

FIG. 8 is a perspective view of a schematic representation of a process for forming a sub-microscopic, holographic or other diffraction grating in a substrate in accordance with the present invention in register;

FIG. 9 is a perspective view of a schematic representation of a process for forming a sub-microscopic, holographic or other diffraction grating using a grating;

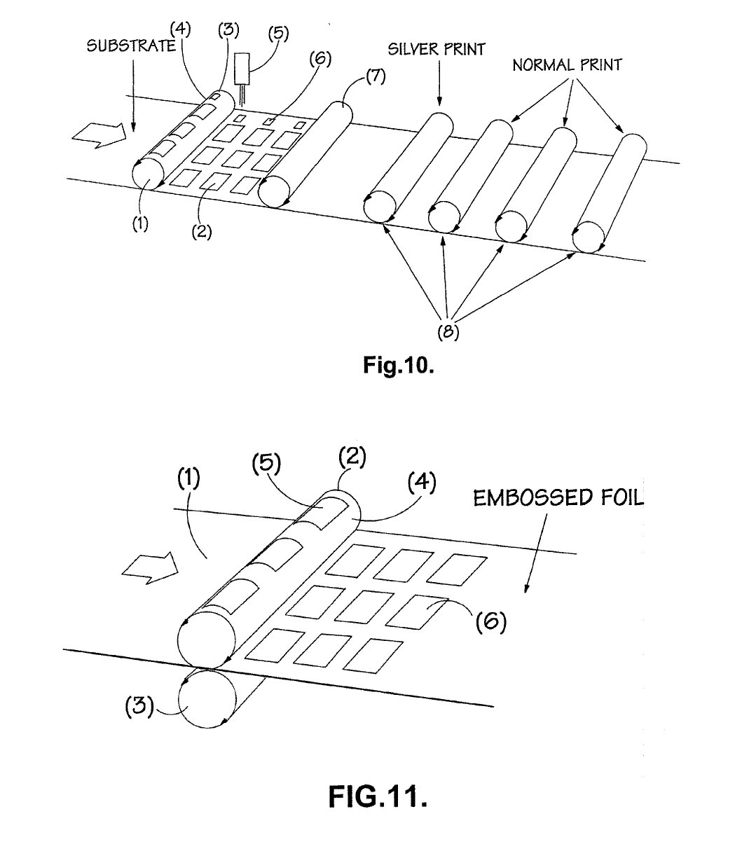

FIG. 10 is a perspective view of a schematic representation using for forming a diffraction grating on a non-embossable substrate in register;

FIG. 11 is a perspective view of a schematic representation of a process for forming a diffraction grating not in register;

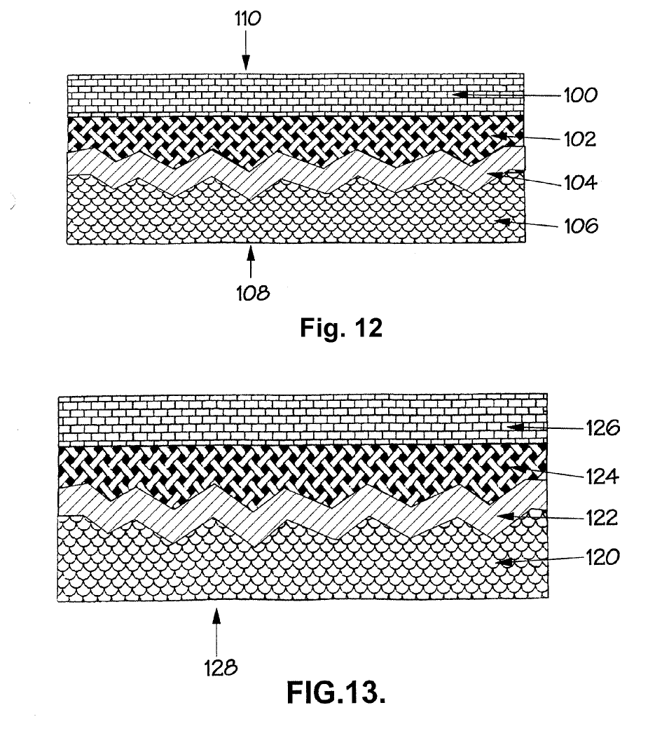

FIG. 12 is a cross-sectional schematic view of one embodiment in accordance with the present invention; and

FIG. 13 is a cross-sectional schematic view of one embodiment in accordance with the present invention.

### EXAMPLE 1

### Direct Ultra Violet Curable Holographic Print Over-Printed with Specially Formulated Metallic Ink (Film)

Referring to FIG. 1, paper, aluminium, or another opaque substrates (1) is printed with an ultra violet curable lacquer (2) on its lower surface. An optically variable device or other lens or engraved structure is cast (3) into the surface of the lacquer (2) with a clear shim (4) having the optically variable device or other lens or engraved structure thereon. The optically variable device or other lens or engraved structure image is imparted into the lacquer and instantly cured (6) via an UV lamp disposed through the shim (4) at normal processing speeds through polarizing lens (8), quartz roller (6), and clear polycarbonate roller (5). The optically variable device or other lens or engraved structure image is a facsimile of the image on the clear shim. Metallic ink (9) is printed (10) over the optically variable device or other lens or engraved structure and causes the optically variable device or other lens or engraved structure to become light reflective. Further colours (11) can be subsequently conventionally printed in-line at normal printing process speeds.

In an alternative embodiment, the paper, aluminium, and all manner of other opaque substrate (1) is replaced with a filmic substrate. Such material is substantially transparent and therefore the image is visible from both sides of the surface.

Instead of the optically variable image forming means shown in FIG. 1 (a transparent cylinder of quartz comprising a transparent plastic material carrying the optically variable image to be applied) a belt system as shown in FIG. 1a can be used.

The belt system comprises a quartz tube having an UV lamp mounted inside, a chilled drive roller and a silicone-polyester belt containing the holographic image. The silicone-polyester belt circulates around the quartz tube and the chilled drive roller.

A paper, aluminium, or another opaque substrates is printed with an ultra violet curable lacquer on its lower surface. The optically variable image is imparted into the lacquer by using the silicone-polyester belt, wherein nip rollers are used to ensure sufficient contact between the silicone-polyester belt and the lacquer coated substrate.

### EXAMPLE 2

### Reverse of Example 1 Above (Film)

As shown in FIG. 2, paper, aluminium, or another opaque substrate (1) is printed conventionally with a number of coloured inks. Using, for example, a Cerutti R950 printer (available from Cerrutti UK Long Hanborough Oxon.) (11), substrate (1) is then printed with an ultra violet curable lacquer (2) on the surface of a paper, aluminium, or another opaque substrate (1). An optically variable device and other lens and engraved structure is cast (3) into the surface of the lacquer (2) with a clear shim (4) having the optically variable device and other lens and engraved structure thereon, the optically variable device and other lens and engraved structure image is imparted into the lacquer and instantly cured (7) via a UV lamp at normal processing speeds through polarizing lens (8), quartz roller (6), and clear polycarbonate roller (5), becoming a facsimile of the image disposed on the clear shim (4). A metallic ink (9) is printed (10) over the optically variable device and other lens and engraved structure and causes the optically variable device and other lens and engraved structure to become light reflective.

In an alternative embodiment, an UV primer, which is applied to the substrate and when exposed to the UV light source is pre-cured. The pre-curing is not complete but stable enough to have received the diffraction pattern or array of sub-microscopic images. The pre-cured coating is then exposed to an additional UV light source and totally cured. In said embodiment alternatively to the UV primers of the free radical type system cationic systems can be used.

In addition to excellent adhesion to metals and polyolefins and other plastics, cationic epoxy based chemistry may offer other benefits, such as, for example, low shrinkage on curing, good flexibility, low odour in the formulation and cured film. Low toxicity and skin irritation, no oxygen inhibition, improved gas barrier properties, good electrical properties, high chemical and solvent resistance and lower viscosity of the resins could aid printability.

In an alternative embodiment, the paper, aluminium, and all manner of other opaque substrate (1) is replaced with a filmic substrate. Such material is substantially transparent and therefore the image is visible from both sides of the surface.

As shown in FIG. 2, a filmic substrate (1) is printed conventionally with a number of coloured inks, using, for example, a Cerutti R950 printer (available from Cerrutti UK Long Hanborough Oxon.) (8). Substrate (1) is then printed with an ultra violet curable lacquer (2). An OVI is cast (3) into the surface of the lacquer (2) with a transparent polymeric shim (4) having the OVI thereon, the holographic image is imparted into the lacquer and instantly cured (5) via a UV lamp (not shown), becoming a facsimile of the OVI disposed on the shim. A metallic ink (6) is printed (7) over the OVI and causes the OVI to become light reflective, the OVI is visible on the first surface of a paper or other non-filmic substrate and both sides of the filmic substrate. In another embodiment, the UV curable lacquer is replaced with an electronic beam curable lacquer and the UV lamp replaced with an electron beam emitting device.

### EXAMPLE 3

### Direct UV (UV Curable Ink)

Referring to FIG. 3, a UV curable variant of the metallic ink is printed on substrate (1) in and/or out of register using standard printing and coating equipment including rotogravure, flexographic, lithographic, screen process and other print methods into any compatible substrate surface. The embossing cylinder is brought into direct contact with the metallised ink (2). Whilst in a liquid state the ink is flash cured virtually instantaneously using a UV light source (3), through the embossing cylinder whilst the embossing cylinder remains in direct contact with the metallic ink. The surface tension of the substrate being greater than that of the embossing shim, die or cylinder causes the ink to adhere to the substrate rather than the embossing shim, in a cured state, replicating and retaining the surface relief characteristics, integrity, holographic, diffractive or other sub-microscopic structure or micro-texture properties and effects within the metallised ink which is now incorporated onto the surface of the substrate.

### EXAMPLE 4

### Reverse of Example 3 Above

FIG. 4 shows the use of a UV curable variant of the metallic ink. An UV type embossing engine is used. The ink is printed (1) in or out of register using standard printing and coating equipment including rotogravure/flexographic methods into any compatible substrate surface. The embossing cylinder is brought into direct contact with the metallised ink (2). Whilst in a liquid state the ink is flash (virtually instantaneously) cured using a UV light source (3), through the embossing cylinder whilst the embossing cylinder remains in direct contact with the metallic ink. The surface tension of the substrate being greater than that of the embossing shim, die or cylinder causes the ink to adhere to the substrate rather than the embossing shim, in a cured state, replicating and retaining the surface relief characteristics, integrity, holographic, diffractive or other sub-microscopic structure or micro-texture properties and effects within the metallised ink which is now incorporated onto the surface of the substrate.

### EXAMPLE 5

### In-Line Printing

FIG. 5 shows that a conventional printing press rotogravure, UV flexographic or similar can have an extra station added, this being an embossing station (1). Using any embossable film (2) either native/raw film/substrate such as co-extruded BOPPs, polyolefin's, polyesters and cellulose or pre-coated/lacquered. The substrate is first embossed (first station) (1) then printed (second station) (3) using a specifically formulated metallic ink to produce the metallised effect. Conventional printing (4) can also be carried out on the same press. As the ink is formulated like a normal ink, conventional printing methods can be utilised. The printing of the metallic ink can be anywhere in the line; it does not have to come directly after embossing. If an encoder for example an indexing machine which marks the sheet or web so that the mark can be recognised by the print operator (5) is placed in the embossing area and the embossing head has specified areas of imagery, then register to print can be achieved. Printing of the metallic ink can be solid, semi translucent etc, with the resulting effect being that in one pass of the printing press metallising, semi-metallising, de-metallising and normal printing of colours in or not in register can be achieved. The specifically formulated metallic ink can be printed on either side of the film, however generally this will be carried out on the embossed side, to encapsulate the holographic embossed image/pattern so that it remains intact, should it come into contact with any filling agents such as liquids, grease, solvents, lacquers, inks or any other surface contaminants or foreign bodies of any kind.

### EXAMPLE 6

### Dual in-Line Printing

A conventional printing press such as, for example, rotogravure, or UV flexographic, can have an extra station added, this being an embossing station. Utilising an existing or adding an additional print station (2), a holographic embossable substantially transparent coating can be printed, coated, or laid down (this coating/lacquer generally being nitrocellulose based, solvent evaporated), either on the whole surface of the substrate, partially or printed in register (for later re-registration by subsequent embossing and or print/coating stations). This area is then ready to be embossed and eliminates the need for pre-coated/lacquered films/substrates.

FIG. 6 shows a substrate first coated/lacquered (first station) (2) then embossed (second station) (1) and then using a third conventional (3) rotogravure/flexographic print station, to print the specially formulated metallised ink on the embossed side of the substrate/film, producing the reflective silver metallised effect, is printed. Then printing of other inks can be carried out as normal (4). The specially formulated metallised ink can be printed on either side of the film, however generally this will be carried out on the embossed side, to encapsulated the holographic embossed image/pattern so that it remains intact, should it come into contact with any filling agents such as liquids, grease, solvents, lacquers, inks or any other surface contaminants such as liquids, grease, solvents, lacquers, inks or any other surface contaminants or foreign bodies of any kind.

### EXAMPLE 7

### Transfer

FIG. 7 is a film that has a release coat, either applied/coated in-line or is part of the film's/substrate's design/construction intentionally, or not is embossed (as in FIGS. 5/6/8), and then printed with the metallic ink, either in register, or not (1), and then an adhesive (2) is applied again either all over or in register with the embossed image, then laminated to various substrates, (paper, board, film) (3). Once the adhesive is cured either in/on or off line the film can then be stripped (4) leaving the embossed and metallic area on the substrate (5), this transferred area can subsequently be over printed, providing either a compatible ink is used or a print receptive coating is applied to assist ink key, again this can be produced in, on or off-line.

### EXAMPLE 8

### Off-Line (in Register) Printing

FIG. 8 is a schematic view of a method to emboss a substrate using either a soft electron beam or UV embosser. This is done by passing a substrate (1) through an embossing cylinder (2) and a nip roller (3), the embossing cylinder (2) has an embossing shim made of plastic or directly on the cylinder (4) with a holographic/diffractive or engraved image (5). Image (6) is embossed into various substrates with heat and/or UV curing. If a registration mark (7) is on the embossing cylinder this will also emboss on to the substrate (8). The substrate is then printed using specially formulated metallic ink on a conventional printing press. The specially formulated metallic ink can be printed down as a solid to give a full metallised effect or different coat weights to give different types of effects i.e., a semi metallised (HRI effect) etc. The substrate can be printed all over or because a registration mark (8) has been embossed on the substrate the specially formulated metallic ink can be printed in specified areas in register with the embossed image and normal printed images. If a transfer substrate is embossed then after printing of the formulated metal ink the substrate can be used for ‘transfer-metallising’ on to paper, board, film and metal foils.

### EXAMPLE 9

### Emboss in Register

Registering a holographic/diffractive embossed area/image to print and or lacquered area or vice versa can be performed using two methods.

### 1. Utilising the Standard Native Embossable Films/Substrates.

The film can be either embossed in register and subsequently printed/over printed, or pre-printed and subsequently embossed in register to the printed areas in-line, on-line or off line, by means of registering and adjusting electronically the embossing cylinder to the subsequent printing cylinder or vice versa, or by means of a holographically, chemically, etched or engraved registration mark incorporated on the embossing shim/cylinder, this will then produce a white/grey registration mark when embossed into the film. For subsequent registration by electronically controlled photo cell either reflective or transmissive and printing in a specified area/areas, thus enabling the embossing station to be positioned anywhere in the machine system configuration, previous to the metallic ink printing that will be used as the reflective background to the holographic/diffractive embossed areas.

### 2. Utilising Lacquers/Coatings on Non-Embossable Films/Substrates.

To facilitate the use of a clear/transparent embossable coating/lacquer on normally unembossable films/substrates for subsequent embossing and printing, a clear/transparent embossable coating/lacquer is printed over the entire surface of the film/substrate for subsequent embossing and/or printing. (see FIG. 9).

FIG. 10: To allow the use of a clear/transparent embossable coating/lacquer on normally unembossable films/substrates for subsequent embossing and printing in register. The use of an ink jet printer/encoder is incorporated on the print station (1) that will be used for the printing of an embossable coating/lacquer, once the embossable coating/lacquer area has been printed (2), the ink jet printer/encoder will register to a registration mark (3), notch, space etc. that is incorporated on the printing cylinder/sleeve/plate (4), once triggered by the electronic photo cell that detects the registration mark, the ink jet printer (5) is electronically/computer controlled to print a registration mark (6) on the film/substrate for later registration and embossing (7) into the embossable lacquer/coated areas (2), and for subsequent registration by further print stations (8) down line.

### EXAMPLE 10

### Off-Line (not in Register) Printing

FIG. 11 shows a schematic of a method to emboss a substrate using either an UV embosser. This is done by passing a substrate (1) through an embossing cylinder (2) and a nip roller (3), the embossing cylinder (2) has an embossing shim made of plastic, or directly on the cylinder (4) with a holographic/diffractive or engraved image (5) to emboss image (6) into various substrates using heat and pressure and/or UV curing. The substrate is then printed using specially formulated metallic ink on a conventional printing press. The ink can be printed down as a solid to give a full metallised effect or different coat weights to give different types of effects i.e., a semi metallised (HRI effect) etc. The substrate can be printed all over. If a transfer substrate is embossed then after printing of the formulated metal ink the substrate can be used for ‘Transfer-metallising’ on to paper, board, film and metal foils. Referring to FIG. 12 a film substrate 100, UV curable lacquer 102 and holographic or other sub-microscopic diffraction grating 104 with metallic ink 106 printed over with both first 108 and second surfaces 110 viewable.

Referring to FIG. 13 a paper substrate 120, UV curable lacquer 122 and holographic or other sub-microscopic diffraction grating 124 with metallic ink 126 printed over with the image viewable through the first surface 128 only.

Examples of an optically variable image or device are holograms or diffraction gratings, moire grating, etc. These optical microstructured images are composed of a series of structured surfaces. These surfaces may have straight or curved profiles, with constant or random spacing, and may even vary from microns to millimetres in dimension. Patterns may be circular, linear, or have no uniform pattern. For example a Fresnel lens has a microstructured surface on one side and a pano surface on the other. The microstructured surface consists of a series of grooves with changing slope angles as the distance from the optical axis increases. The draft facets located between the slope facets usually do not affect the optical performance of the Fresnel lens.
A positive Fresnel lens can be designed as a collimator, collector or with finite conjugates. These lenses are usually corrected for spherical aberration. They can also be coated for use as a second surface reflector.
A negative Fresnel lens is the opposite of a positive lens with diverging light rays. They can be coated for use as a first surface reflector.
A Fresnel cylindrical lens has a linear Fresnel structure. It collects light in one direction and the result is a line image instead of a point image.
Lenticular have linear structures where every groove has a small radius creating multiple line images. Lenticular are primarily used for projection screen and printed three-dimensional images.

Besides various diffraction grating structures like, holograms, kinegrams, direct write etc. other structures which may be included to augment these.
Images which are ‘hidden’ in a plane grating structure (Hidden Indicia) which looks to the naked eye like a matt area or lens structure. Information which is embedded in the structure can be text (a date or alpha numeric code) a logo or portrait which can be revealed by shining a laser pen through the image and projecting the information or images in real time.
A well established system, these are planar gratings prepared by means of a precision ruling engine with a diamond cutting tool. Gratings can be ruled on a variety of substrates; for example, glass, metal and ceramic. Groove density ranges from 20 to 1899 grooves/mm. For example the Ramsden wood gratings are equidistant circular grooves which are 1,700,000 of an inch apart, and formed the basis for the first diffraction pattern films and stamping foils.
Planar gratings with finely spaced grooves used at glancing angles in order to diffract UV light (UV, VUV, FUV and EUV) and soft X-rays.
Aberration corrected holographic, curved gratings minimize optical aberrations, such as coma, in grating-based systems. These are essential components in simple, compact, high-throughput spectrographs and monochromators, and diffraction systems employing fibre optics or solid state array detectors, or both.
One way to achieve very short l.a.s.e.r. light pulses is to use a pair of special planar diffraction gratings to compress the duration of the pulse. Gratings are made of thermally stable, temperature resistant materials to withstand intense l.a.s.e.r. light. Ultra short l.a.s.e.r. pulses are mainly used in research of fast transient phenomena.
The optically variable image can also be a zero-order diffractive microstructure having special colour effects—for example, colour change upon tilting and/or rotation. The use of zero-order diffractive microstructure as security devices in a variety of applications like banknotes, credit cards, passports, tickets, document security, anti-counterfeiting, brand protection and the like is known.

The possibility of counterfeiting decreased further by adding thermo- or photochromic dyes, UV/IR fluorescent dyes, magnetic stripes etc. into the OVD primer or ink.

The products obtained by the process of the present invention are new.

Accordingly, the present invention relates also to a (security) product obtainable using the method according to the present invention.

In preferred embodiment of the present invention the (security) product is based on paper, aluminium, or another opaque substrate.

The (security) product is preferably a banknote, passport, identification card, drivers license, compact disc or packaging.

1. An apparatus for forming a (security) product comprising a printing press and optically variable image forming means, wherein the optically variable image forming means comprise
a) a transparent carrier,
b) a transparent material which carries an optically variable image to be applied, and
c) means to dry or cure a varnish.

2. The apparatus as claimed in claim 1 wherein the transparent carrier is a cylinder, a belt or a plate.

3. The apparatus as claimed in claim 1 wherein the optically variable image forming means comprise
a) a transparent cylinder of quartz,
b) a transparent plastic material carrying the optically variable image to be applied, which is mounted on the surface of the quartz cylinder,
(c) means to dry or cure the varnish arranged within the transparent cylinder; or
a) a transparent polyester belt,
b) a transparent plastic material carrying the optically variable image to be applied, which is mounted on the surface of the polyester belt,
(c) means to dry or cure the varnish arranged within the transparent cylinder.

4. The apparatus as claimed in claim 1 wherein the printing press comprises any one or more of a feed system; means to carry an image to be printed; means to apply an ink to; means to dry or cure the ink; and means to carry a printed security product.

5. The apparatus as claimed in claim 1 wherein the printing press comprises in line, the optically variable image forming means to transfer the optically variable image to a substrate.

6. A method for forming an optically variable image on a substrate comprising the steps of:
A) applying a curable compound, or composition to at least a portion of the substrate;
B) contacting at least a portion of the curable compound with optically variable image forming means;
C) curing the curable compound and
D) optionally depositing a metallic ink on at least a portion of the cured compound, wherein the optically variable image forming means comprise
a) a transparent carrier,
b) a transparent material which carrys an optically variable image to be applied, and
c) means to dry or cure a varnish.

7. The method as claimed in claim 6 wherein the optically variable image forming means comprise
a) a transparent cylinder of quartz,
b) a transparent plastic material carrying the optically variable image to be applied, which is mounted on the surface of the quartz cylinder,
(c) means to dry or cure the varnish arranged within the transparent cylinder.

8. The method as claimed in claims 6, wherein a colored, or metallic ink is deposited on a substrate, on which the optically variable image is formed; before forming the optically variable image on at least a portion of the colored, or metallic ink.

9. A method as claimed in any one of claim 6, wherein the substrate is a non-transparent (opaque) sheet material.

10. A method as claimed in claim 6 wherein the curable composition is a lacquer.

11. A method as claimed in claim 10 wherein the curable composition is deposited by means of gravure or flexographic printing.

12. A method as claimed in claim 10, wherein the curable lacquer is cured by means of an ultraviolet (U.V.) light or an electron beam.

13. A method as claimed in claim 6 wherein the metallic ink comprises any one or more metal selected from the group comprising aluminium, stainless steel, nichrome, gold, silver, platinum and copper.

14. A (security) product obtained by the method as claimed in claim 6.

15. The (security) product as claimed in claim 14, which is a banknote, an identification document, a pharmaceutical, apparel, software, a compact disc or tobacco.

16. Optically variable image forming means, comprising
a) a transparent carrier,
b) a transparent material which carries an optically variable image to be applied, and
c) means to dry or cure a varnish.

17. The optically variable image forming means as claimed in claim 16 wherein the transparent carrier is a cylinder, a belt or a plate.

18. The optically variable image forming means as claimed in claim 16 wherein the optically variable image forming means comprise
a) a transparent cylinder of quartz,
b) a transparent plastic material carrying the optically variable image to be applied, which is mounted on the surface of the quartz cylinder,
(c) means to dry or cure the varnish arranged within the transparent cylinder; or
a) a transparent polyester belt,
b) a transparent plastic material carrying the optically variable image to be applied, which is mounted on the surface of the polyester belt,
(c) means to dry or cure the varnish arranged within the transparent cylinder.
